(19) United States
(12) Patent Application Publication
(10) Pub. No.: US 2010/0091841 A1
(43) Pub. Date: Apr. 15, 2010

(54) SYSTEM AND METHOD OF OPTIMIZED BIT EXTRACTION FOR SCALABLE VIDEO CODING

(75) Inventors: Faisal Ishtiaq, Chicago, IL (US); Shih-Ta Hsiang, Schaumburg, IL (US); Aggelos K. Katsaggelos, Chicago, IL (US); Ehsan Maani, Chicago, IL (US); Serhan Uslubas, Dallas, TX (US)

Correspondence Address: Motorola, Inc.;Law Department, 1303 East Algonquin Road, 3rd Floor, Schaumburg, IL, 60196, US

(73) Assignees: MOTOROLA, INC., Schaumburg, IL (US); NORTHWESTERN UNIVERSITY, Evanston, IL (US)

(21) Appl. No.: 12/575,156

(22) Filed: Oct. 7, 2009

Related U.S. Application Data
(60) Provisional application No. 61/103,355, filed on Oct. 7, 2008.

(51) Int. Cl. H04N 7/26; H04N 7/64; H04N 7/24

(52) U.S. Cl. 375/240.02; 375/240.27; 375/E07.279; 375/E07.022; 375/E07.126

(57) ABSTRACT

A device for use with a frame generating portion that is arranged to receive picture data corresponding to a plurality of pictures and to generate encoded video data for transmission across a transmission channel having an available bandwidth. The frame generating portion can generate a frame for each of the plurality of pictures to create a plurality of frames. The encoded video data is based on the received picture data. The device includes a distortion estimating portion and inclusion determining portion and an extracting portion. The distortion estimating portion can estimate a distortion. The inclusion determining portion can establish an inclusion boundary based on the estimated distortion. The extracting portion can extract a frame from the plurality of frames based on the inclusion boundary.

The present application claims priority from U.S. Provisional Application No. 61/103,355 filed Oct. 7, 2008, the entire disclosure of which is incorporated herein by reference.

### BACKGROUND

With the drastic improvements and developments of the network infrastructures, multimedia applications for a variety of devices with different capabilities have become very popular. These devices range from cell phones and PDA's with small screens and restricted processing power to high-end PCs with high-definition displays. These devices are mainly connected to different types of networks with various bandwidth limitations and loss characteristics. Addressing this vast heterogeneity is a considerably tedious task. A highly attractive solution which has been under development for the past 20 years is known as scalable video coding. The term “scalability” here means that certain parts of the bitstream can be removed in order to adapt it to the various requirements of end users as well as to varying network conditions or terminal capabilities.

An H.264/AVC scalable video coding standard, or often referred to as SVC, is an extension (Annex G) of the H.264/AVC video coding for video compression. The H.264/AVC standard is a form of the Moving Pictures Expert Group (MPEG) video compression standard based on motion-compensation. Motion-compensation is a technique often used in video compression in which a frame is described in terms of the transformation with respect to a reference frame. The reference frame may be previous in time or even from the future. This will be described in further detail below.

In MPEG video compression, frames can be grouped into sequences called a group of pictures (GOP). Each coded video stream consists of successive GOPs. A GOP can contain three main frame types: an I-frame, P-frame, or B-frame. An I-frame (intra-coded frame) is a reference frame which represents a fixed image and is independent of other picture types. A P-frame (predictive coded frame) contains motion-compensated information from a preceding I- or P-frame, and therefore is more compressible than an I-frame. For example, it may contain motion vectors that describe a transformation in reference to a preceding I- or P-frame. Finally, a B-frame (bi-directionally predictive coded frame) contains difference information from a preceding and following I- or P-picture within a GOP, and therefore can obtain the highest amount of data compression. An example of the different types of frames within a GOP will now be described in reference to FIG. 1.

FIG. 1 illustrates how different types of frames can compose a GOP in an MPEG video sequence. As illustrated, an example MPEG video sequence includes an I-frame 102, a B-frame 104, a B-frame 106, a P-frame 108, a B-frame 110, a B-frame 112 and an I-frame 114.

In this example, a GOP 116 includes six frames: I-frame 102, B-frame 104, B-frame 106, P-frame 108, B-frame 110 and B-frame 112. This particular example video consists of a sailboat slowly moving across an ocean, with a bird flying in the background. I-frame 102 (a reference frame) includes all the pictorial information: sailboat, ocean, sun, flying bird. In contrast, P-frame 108, which is predicted from I-frame 102, only includes the change with respect to I-frame 102; for example, since the sun and ocean do not really move, only the new positions of the sailboat and flying bird (moving objects) are contained within P-frame 108. Similarly, B-frame 106 contains only transformational information, as it is predicted from I-frame 102 and P-frame 108. In this particular example, since the sailboat is moving much slower than the flying bird, the only real difference between I-frame 102 and P-frame 108 is the position of the flying bird as it moves across the frame. Therefore, B-frame 106 contains only information describing the new position of the flying bird. Similarly, B-frame 104 is then predicted from I-frame 102 and B-frame 106, and contains only the change in the flying bird's position. In a similar fashion, B-frames 110 and 112 are predicted from P-frame 108 and I-frame 114. Note that I-frame 114 (the start of the next GOP) illustrates the full image information, now without the bird since it has moved off the frame.

Note that out of the six frames in GOP 114, only one frame (I-frame 102) contains information describing a full image; P-frame 108 contains only the transformation with respect to I-frame 102, B-frame 106 contains only the transformation with respect to I-frame 102 and P-frame 108, and so on. In this manner, it can be seen than since they contain only transformations with respect to a reference frame, P-frames contain much less information than I-frames, and that B-frames contain even less information than P-frames. Thus the use of B-frames and P-frames within a GOP is often implemented in MPEG video compression in order to provide for very high compression ratio.

As mentioned previously, SVC is a standardized extension of an MPEG video compression standard (H.264/AVC). SVC allows for spatial, temporal, and quality scalabilities. Spatial scalability and temporal scalability describe cases in which subsets of the bit stream represent the source content with a reduced picture size (spatial resolution) or frame rate (temporal resolution). With quality scalability, the substream provides the same spatio-temporal resolution as the complete bit stream, but with a lower fidelity—where fidelity is often measured by signal-to-noise ratio (SNR). The SVC design enables the creation of a video bitstream that is structured in layers, consisting of a base layer and one or more enhancement layers. Each enhancement layer either improves the resolution (spatially or temporally) or the quality of the video sequence. The superb adaptability of the SVC and its acceptable coding efficiency make SVC a suitable candidate for many video communication applications such as multi-cast, video surveillance, and peer-to-peer video sharing.

In SVC, temporal scalability is provided by the concept of hierarchical B-frames within a GOP. This will be discussed in further detail later with reference to FIGS. 3A and 3B. Spatial scalability is achieved by encoding each supported spatial resolution into one layer. In each spatial layer, motion-compensated prediction and intra-prediction are employed similar to AVC. Nonetheless, in order to further improve coding efficiency, inter-layer prediction mechanisms are incorporated.

Quality scalability can be seen as a special case of spatial scalability with identical picture sizes for base and enhancement layers. The same prediction techniques are utilized except for the corresponding upsampling operations. This type of quality scalability is referred to as coarse-grain quality scalable coding (CGS). Since CGS can only provide a discrete set of decoding points, a variation of the CGS approach, which is referred to as medium-grain quality scalability (MGS), is included in the SVC design to increase the flexibility of the bit stream adaptation.

The coded video data of the SVC are organized into packets with an integer number of bytes, called Network Abstraction Layer (NAL) units. Each NAL unit belongs to a specific spatial, temporal, and quality layer. Moreover, a set of NAL units from all spatial layers having the same temporal instant constitute an Access Unit (AU).

FIG. 2 includes a schematic 200 illustrating example applications of SVC. FIG. 2 includes a video stream generator 202, a video encoder 204, and a set of target elements 222. Video encoder 204 includes an extractor 220, and target elements set 222 includes a cell phone 206, a HDTV 208, and a personal computer (PC) 210.

Video stream generator 202 provides the original video stream (containing all the frames with all the information) to video encoder 204 via channel 212. Video encoder 204 then encodes the frames into a bitstream consisting of GOPs (containing I, P, and B-frames) similar to that shown in FIG. 1. With SVC, video encoder 204 is capable of outputting substreams of varying spatial, temporal, and quality levels. This is useful because the target elements (cell phone 206, HDTV 208, PC 210) all have varying levels of spatial resolution. For example, HDTV 208 may be capable of displaying video with a maximum resolution of 1920×1080, but cell phone 206 may only be capable of displaying video with a maximum resolution of 320×240. PC 210 may be somewhere in the middle with a maximum resolution of 1024×768. Further, the individual transmission rates from video encoder 204 to each of target elements 222 may vary; channel 214 (to cell phone 206) is a wireless channel that likely cannot support a bit rate as high as a wired channel (e.g. channel 218 to PC 210). Therefore, SVC is employed in order for each target element to be able to receive a substream that is scaled (temporally, spatially, quality-wise) in a manner appropriate for its spatial resolution and channel bit rate. For example, SVC would allow for channel 214 to transmit a low spatial resolution substream (with only base quality and frame rate) to cell phone 206, whereas it would allow for channel 216 to transmit a much higher quality substream (with high SNR quality, high spatial resolution, high frame rate) to HDTV 208.

A key element of SVC is bit stream extraction. In order to extract a substream with a particular average bit rate and/or resolution, a bit stream extractor is employed. Bit stream extractor 220 lies within video encoder 204, which determines the specific substream to be extracted from the entire coded bit stream by deciding which NAL units to send, depending on the channel bit rate and target resolution for each target. For example, based on the spatial resolution of PC 210 and the bit rate of channel 218, bit stream extractor 220 determines the substream to be sent to PC 210 by deciding which NAL units of the entire coded bitstream are to be sent and which are to be discarded.

It should be noted that bit stream extractor 220 does not need to lie within video encoder 204. In some cases, a bit stream extractor may be a separate device from encoder an encoder.

The issue with bit stream extraction is that there usually exists a huge number of possibilities (especially for MGS coding) that result in, approximately, the same bit rate. A very naïve method is to randomly discard NAL units until the desired bit rate is achieved. Nonetheless, the efficiency of the bit extractor can be substantially improved by assigning a priority identifier to each NAL unit during the encoding or a post-processing operation. The priority identifier is directly related to the contribution of the NAL unit in the overall quality of the video sequence. Therefore, bit stream extractor 220 first discards the NAL units with the lowest priority in order to reach the target bit rate of the given channel. In the example mentioned above regarding the substream sent to PC 210, this may involve discarding all NAL units corresponding to certain enhancement temporal, spatial, and quality levels and only keeping those corresponding to basic temporal, spatial and quality levels.

The problem of optimal extraction of the NAL units is a challenging task due to various temporal and spatial dependencies. The implementation of the different scalabilities of SVC (temporal, quality, spatial) will now be described in further detail in order to examine the various dependencies and to describe the conventional bit stream extraction methods.

As mentioned previously, in SVC temporal scalability is implemented by the use of hierarchical B-frames within a GOP. This will be now discussed in reference to FIGS. 3a and 3b.

FIG. 3A shows a diagram 300 which illustrates the temporal scalability of a single-resolution, single quality SVC bitstream. Diagram 300 includes a Temporal Layer 0 (TL0) 302, a Temporal Layer 1 (TL1) 304, a Temporal Layer 2 (TL2) 306, and a Temporal Layer 3 (TL3) 308. The x-axis displays the playback order number for each frame, where the y-axis displays the temporal layer number.

In this example, the bit stream is broken into four temporal layers—TL0, TL1, TL2 and TL3. Starting from the bottom, Temporal Layer 0 represents the base temporal layer and includes frames 314 and 316, which are either I-frames or P-frames. The next level up, TL1, includes only frame 318. Frame 318 is a B-frame which is predicted from frames 314 and 316, as indicated by the arrows. The next temporal layer, TL2, includes frames 320 and 322, which are B-frames based on 314 and 318 and on 318 and 316, respectively. The final temporal layer, TL3, includes frames 324, 326, 328, and 330 which are all B-frames based on frames from the previous temporal layers as indicated by the arrows.

Diagram 300 illustrates an example of the hierarchical prediction structure implemented in SVC bitstreams. Since, for example, the frames in TL2 are predicted from the frames in TL1 and in TL0, TL2 is said to be dependent on TL1 and TL0; thus a bit stream extractor should only include TL2 if both TL1 and TL0 were also included. Thus for extracting temporally scaled substreams from this bit stream, there are only four possibilities: include TL0 only, include TL0+TL1, include TL0+TL1+TL2, or include TL0+TL1+TL2+TL3. A substream including all temporal layers (TL0+TL1+TL2+TL3) would correspond to the highest temporal level (and would have the maximum frame rate), whereas a substream including only one temporal layer (TL0) would correspond to the lowest temporal level (would have the minimum frame rate).

FIG. 3B illustrates diagram 310 which includes all the frames from FIG. 3a arranged sequentially, in playback order. GOP 312 includes frames 324, 320, 326, 318, 328, 322, 330, and 316. GOP 312 represents an example GOP for a single-resolution, single-quality bit-stream of the highest temporal level (all temporal layers included). In order to scale-down or decrease the temporal level, the bit stream extractor can simply remove temporal layers, starting with TL3. For example, if the bit stream extractor decides to remove TL3, then frames 324, 326, 328 and 330 will all be discarded, and only frames 320, 318, 322, and 316 will remain. If the bit stream extractor decides to scale down the temporal level further, TL2 may then also be removed, thus additionally discarding frames 320 and 322 and keeping only frames 318 and 316.

In FIG. 3B, GOP 312 is of a fixed spatial resolution and fixed SNR quality level. In SVC, SNR quality is also scalable and structured in layers. Quality scalability will now be discussed in reference to FIG. 4.

FIG. 4 includes a block 400, which illustrates the SNR quality scalability for a fixed spatial-resolution SVC bitstream. Block 400 includes GOP 312, GOP 402, GOP 404, GOP 406.

GOP 312 is from FIG. 3B and represents a bit stream with the highest temporal level but with the lowest SNR quality (Quality Layer 0). Quality Layer 0 is sometimes referred to as the “Base Layer” since it represents the basic SNR quality, without any quality enhancements. GOP 402 (Quality Layer 1) is structured in temporal layers in a manner identical to that of GOP 312, but is structured such that when added to GOP 312, its frames provide for an increment in SNR quality. Similarly, the addition of GOP 404 (Quality Layer 2) provides for an additional increment of SNR quality. Finally, the addition of GOP 406 (Quality Layer 3) provides for a further increment of SNR quality, resulting in the highest possible level of SNR quality.

As with temporal scalability, a bit stream extractor can choose to discard SNR quality layers (starting with Quality Layer 3) in order to do scale down the SNR quality as appropriate for the target. For example, a bit stream extractor can choose to discard Quality Layer 3 (GOP 406) and keep only Quality Layers 2, 1, and 0 (GOP 404, 402, 312).

In the example of FIG. 4, block 400 illustrated the structure of an SVC bit stream of a single spatial resolution. In SVC, spatial resolution is also scalable and structured in layers. Spatial scalability will now be discussed in reference to FIG. 5.

FIG. 5 shows a full bitstream 500, which illustrates the spatial scalability of an SVC bitstream. Full bitstream 500 includes block 400, block 502, block 504, and block 506.

Block 400 is from FIG. 4 and represents an SVC bitstream with the highest SNR quality and highest temporal quality (contains all temporal and quality layers) but with the lowest spatial resolution. Block 502 is an SVC bitstream that is structured in the same way as block 400, but is structured such that when added to block 400, it provides for a bitstream with a higher spatial resolution. Similarly, block 504 is structured such that when added to blocks 400 and 502, the resulting bitstream has an even higher spatial resolution. Finally, the addition of block 506 provides for a further increase in spatial resolution, resulting in the highest possible level of spatial resolution (largest size).

Full bitstream 500 represents an SVC bitstream that includes all the possible temporal, quality, and spatial layers. As mentioned earlier, to scale down this bitstream, the bit stream extractor must decide which frames, or NAL units, from full bitstream 500 must be discarded. In conventional bit stream extraction methods, scalability is implemented by discarding entire temporal, quality, or spatial layers. This will be further discussed in reference to FIGS. 6-8.

FIG. 6 includes a substream 600, which illustrates an example of a spatially-scaled SVC bitstream. Substream 600 includes block 400 and block 502.

Note that unlike full bitstream 500 (which includes all four spatial layers), substream 600 includes only two spatial layers (blocks 400 and 502). So in this case, the bit stream extractor has decided to simply discard the top two spatial layers (blocks 504 and 506 of FIG. 5). In this manner, full bitstream 500 has been scaled down to a lower spatial resolution.

FIG. 7 includes a substream 700, which illustrates an example of a quality-scaled SVC bitstream. Substream 700 includes blocks 702, 704, 706 and 708.

Note that in each of blocks 702, 704, 706 and 708, the top two quality layers (Quality Layers 2 and 3) are not present; only Quality Layers 0 and 1 are present. Thus in this case, the bit stream extractor has decided to discard Quality Layers 2 and 3 in each spatial layer. In this manner, full bitstream 500 has been scaled down to a lower quality level.

FIG. 8 includes a substream 800, which illustrates an example of a temporally-scaled SVC bitstream. Substream 800 includes blocks 802, 804, 806 and 808.

In each of blocks 802, 804, 806, and 808, Temporal Layer 3 is missing; only Temporal Layers 0, 1, and 2 are present. Thus, in this case, the bit stream extractor has decided to discard Temporal Layer 3 in each quality layer and in each spatial layer. In this manner, full bitstream 500 has been scaled down to a lower temporal level.

Note that FIGS. 6-8 represent examples of conventional methods of scaling a SVC bitstream; entire layers are typically discarded in order to appropriately scale the bitstream for a given target. As mentioned earlier in reference to FIG. 2, the issue with bit stream extraction is that there usually exists a very large number of possibilities to adapt a scalable bit stream to a particular average bit rate. The target average bit rate can be acquired by discarding different quality refinement NAL units; temporal, quality or spatial layers (or some combination thereof) can be discarded. Therefore, the reconstructed video sequence that corresponds to the given target bit rate depends on the extraction method used. The conventional basic extraction process defined in the SVC utilizes the high-level syntax elements dependency_id, temporal_id, and quality_id for prioritization.

The application/device for which the video is being decoded usually determines the target spatial and temporal resolutions. Therefore, the base layer of each spatial and temporal resolution lower or equal to the target spatial and temporal resolutions have to be included first. Next, for each lower spatial resolution, NAL units of higher quality levels are ordered in increasing order of their temporal level. Finally, for the target spatial resolution, NAL units are ordered based on their quality level and are included until the target bit rate is reached.

A major drawback of this conventional basic extraction method is that its prioritization policy is independent of the video content. Since the distortion of a frame depends on the content of the frame in addition to the quantization parameter used, only a content-aware prioritization policy can ensure optimal extraction. Considering the fact that the standard does not specify the extraction process, one can devise an alternative, more efficient process.

What is needed is a bit stream extraction system and method that can optimally and efficiently extract NAL units from an SVC bit stream.

### BRIEF SUMMARY

The present invention provides a system and method to optimally and efficiently extract NAL units from an SVC bit stream, in order to provide a scaled substream that results in minimal distortion for a given bit rate, or that can maximize the resulting bit rate for a given acceptable distortion.

In accordance with an aspect of the present invention, device may be used with a frame generating portion that is arranged to receive picture data corresponding to a plurality of pictures and to generate encoded video data for transmission across a transmission channel having an available bandwidth. The frame generating portion can generate a frame for each of the plurality of pictures to create a plurality of frames. The encoded video data is based on the received picture data. The device includes a distortion estimating portion and inclusion determining portion and an extracting portion. The distortion estimating portion can estimate a distortion. The inclusion determining portion can establish an inclusion boundary based on the estimated distortion. The extracting portion can extract a frame from the plurality of frames based on the inclusion boundary.

Additional advantages and novel features of the invention are set forth in part in the description which follows, and in part will become apparent to those skilled in the art upon examination of the following or may be learned by practice of the invention. The advantages of the invention may be realized and attained by means of the instrumentalities and combinations particularly pointed out in the appended claims.

### BRIEF SUMMARY OF THE DRAWINGS

The accompanying drawings, which are incorporated in and form a part of the specification, illustrate an exemplary embodiment of the present invention and, together with the description, serve to explain the principles of the invention. In the drawings:

FIG. 1 includes a diagram, which illustrates how different types of frames can compose a GOP in an MPEG video sequence;

FIG. 2 illustrates example applications of SVC;

FIG. 3A includes a diagram, which illustrates the temporal scalability of a single-resolution, single quality SVC bitstream;

FIG. 3B includes a diagram, which includes all the frames from FIG. 3A arranged sequentially, in playback order;

FIG. 4 includes a block, which illustrates the SNR quality scalability for a fixed spatial-resolution SVC bitstream;

FIG. 5 includes a full bitstream, which illustrates the spatial scalability of an SVC bitstream;

FIG. 6 includes a substream, which illustrates an example of a spatially-scaled SVC bitstream;

FIG. 7 includes a substream, which illustrates an example of a quality-scaled SVC bitstream;

FIG. 8 includes a substream, which illustrates an example of a temporally-scaled SVC bitstream;

FIG. 9 illustrates example applications of SVC, in accordance with aspects of the present invention;

FIG. 10 includes a graph, which illustrates the transmission rate of each NAL unit in a single-resolution SVC bitstream as a function of its quality layer (x-axis) and its play backorder (y-axis);

FIG. 11 illustrates an example inclusion map showing the selection of NAL units in a single-resolution SVC bitstream, in accordance with an aspect of the present invention;

FIG. 12 includes a graph, which illustrates the graph of FIG. 10 with the addition of an inclusion border, indicating the NAL units that are included in the extracted substream;

FIG. 13 shows a diagram of a full bitstream with four spatial layers with example inclusion maps drawn for each spatial layer;

FIG. 14 illustrates an extracted substream based on the inclusion maps drawn for the full bitstream of FIG. 13;

FIG. 15 illustrates an example method of bit stream extraction to maximize transmission rate for a given distortion in accordance with an aspect of the present invention;

FIG. 16 illustrates an example method of bit stream extraction to minimize distortion for a given bit rate in accordance with an aspect of the present invention;

FIG. 17 includes a diagram, which illustrates the parent-child relationships for an example GOP of size 4;

FIG. 18 includes a graph, which illustrates the comparison between the estimated versus the actual distortion for a random selection map of a CIF sequence;

FIG. 19 includes a diagram, which demonstrates the packetization scheme for NAL units;

FIG. 20 includes a graph, which illustrates an example of inclusion and channel coding rate functions for a single resolution bit stream;

FIGS. 21A-C show three graphs, which illustrate the performance of the three extraction approaches for three different test sequences; and

FIGS. 22A-C show three graphs, which illustrate the average PSNR of the decoded sequence of three extraction and error protection schemes for three different test sequences.

### DETAILED DESCRIPTION

In accordance with an aspect of the present invention, a bit stream extractor is able to efficiently select NAL units within SVC layers to create a scaled substream with the minimum estimated distortion for a given bit rate.

In accordance with another aspect of the present invention, the bit stream extractor is able to efficiently select NAL units within SVC layers to create a scaled substream with the minimum estimated distortion for a given bit rate and to address the problem of known packet losses over networks.

In accordance with another aspect of the present invention, the bit stream extractor is able to efficiently select NAL units within SVC layers to create a scaled substream with the minimum estimated distortion for a given bit rate and to address the problem of a known packet loss gradient over networks.

In accordance with another aspect of the present invention, a bit stream extractor is able to efficiently select NAL units within SVC layers to create a scaled substream with the maximum bit rate for a given maximum distortion.

In accordance with another aspect of the present invention, the bit stream extractor is able to efficiently select NAL units within SVC layers to create a scaled substream with the maximum bit rate for a given maximum distortion and to address the problem of known packet loss over networks.

In accordance with another aspect of the present invention, the bit stream extractor is able to efficiently select NAL units within SVC layers to create a scaled substream with the maximum bit rate for a given maximum distortion and to address the problem of a known packet loss gradient over networks.

As discussed previously, conventional methods of SVC bit stream extraction typically involve discarding entire temporal/spatio/quality layers in order to match a target bit rate and spatial resolution. Since the actual content of the NAL units are not taken into account, the extracted substream (in terms of distortion, etc) will likely be suboptimal. In accordance with an aspect of the present invention, an algorithm can accurately and efficiently approximate both source and expected distortion of the resulting video sequence for any subset of the available NAL units. Then, in accordance with an aspect of the present invention, using a model based on optimizing bit rate and/or distortion, the optimal set of NAL units can be efficiently selected.

An example encoder in accordance with an aspect of the present invention will now be discussed below in reference to FIG. 9.

FIG. 9 includes a schematic 900 illustrating example applications of SVC in accordance with aspects of the present invention. FIG. 9 includes a video stream generator 202, a video encoder 902, and a set of target elements 222. FIG. 9 differs from FIG. 2 in that video encoder 204 of FIG. 2 is replaced with an example video encoder 902 in accordance with aspects of the present invention. Video encoder 902 includes a bit stream extractor 904, which includes a frame generating portion 906, a distortion estimating portion 908, an inclusion determining portion 910 and an extracting portion 912.

Video stream generator 202 provides the original video stream (containing all the frames with all the information) to video encoder 204 via channel 212. It should be noted that the original video stream is made up of a plurality of individual pictures, each having picture data. As such, video encoder 902 is arranged to receive picture data corresponding to a plurality of pictures. Video encoder 902 is able to generate encoded video data based on the received picture data. The encoded video data will then be able to be transmitted across a transmission channel having an available bandwidth, for example channel 214 to cell phone 206, channel 216 to HDTV 208 and channel 218 to PC 210.

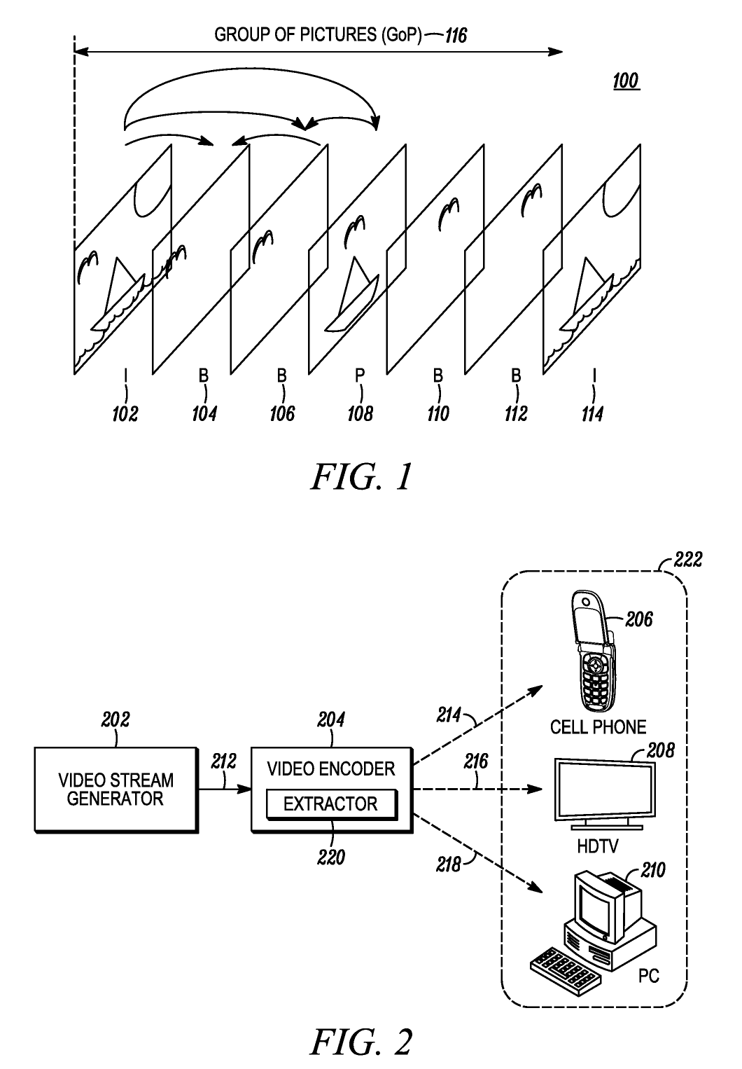

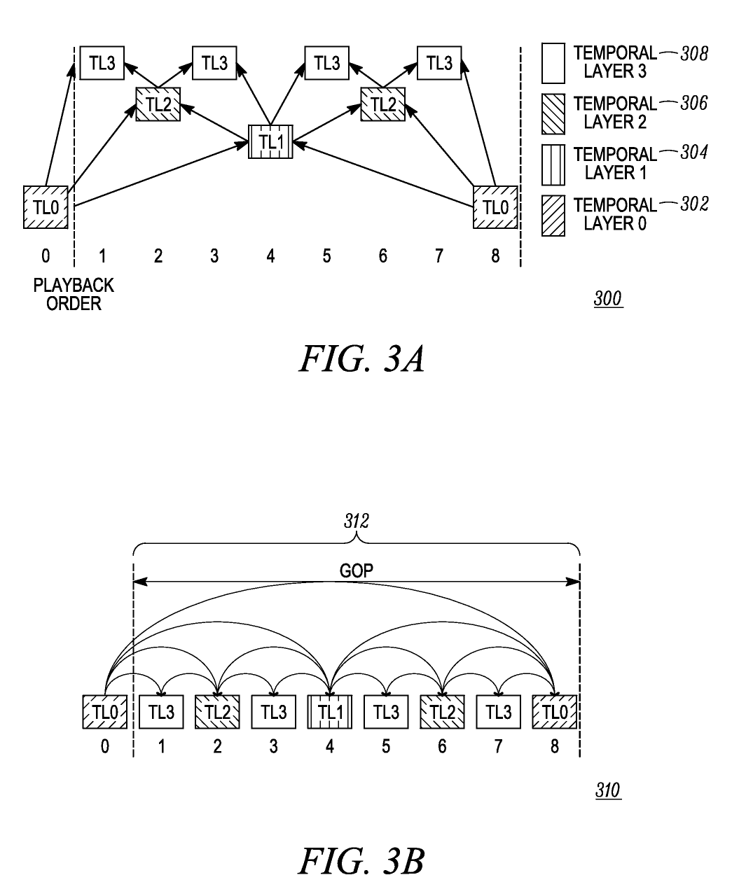

Frame generating portion 906 can generate a frame for each of the plurality of pictures to create a plurality of frames, for example discussed above with reference to FIG. 1.

Distortion estimating portion 908 can estimate a distortion. As will be discussed in more detail below, in accordance with an aspect of the present invention, distortion estimating portion 908 can estimate a distortion that transmitted data will encounter when transmitted over a transmission channel, for example, transmission channel 214 to cell phone 206.

Further, in some embodiments, distortion estimating portion 908 can estimate a distortion that transmitted data will encounter over a communication channel having a known amount of packet loss. For example, presume that a user of cell phone 206 is driving in a car along a road with very good cellular reception. It may be known that channel 214 has an amount of packet loss such that cell phone 206 will not receive 1 out of every 50 image frames that were transmitted. Distortion estimating portion 908 will be able to take such a packet loss into account when estimating a distortion.

Still further, in some embodiments, distortion estimating portion 908 can estimate a distortion that transmitted data will encounter over a communication channel having a known packet loss gradien gradient. Again, presume that a user of cell phone 206 is driving in a car along a road with very good cellular reception, during a first time period. Again, it may be known that at the first time period, channel 214 has an amount of packet loss such that cell phone 206 is not receiving 1 out of every 50 image frames that were transmitted. Now, presume that the user of cell phone 206 is driving in the car along the road with very bad cellular reception, during a second time period. It may be known that at the second time period, channel 214 has an amount of packet loss such that cell phone 206 is not receiving 3 out of every 50 image frames that were transmitted. The change in the amount of packet loss in channel 214 from the first time period to the second time period is referred to as the packet loss gradient. Distortion estimating portion 908 will take such a packet loss gradient into account when estimating a distortion.

Inclusion determining portion 910 can establish an inclusion boundary of the substreams of varying spatial, temporal, and quality levels based on the estimated distortion, as will be discussed in more detail below.

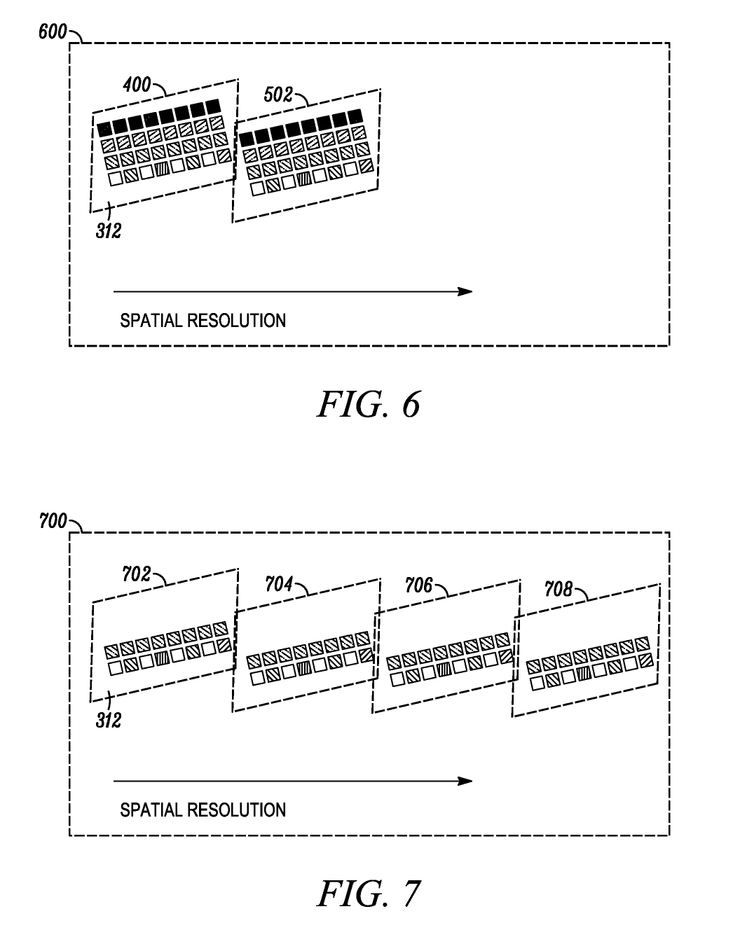

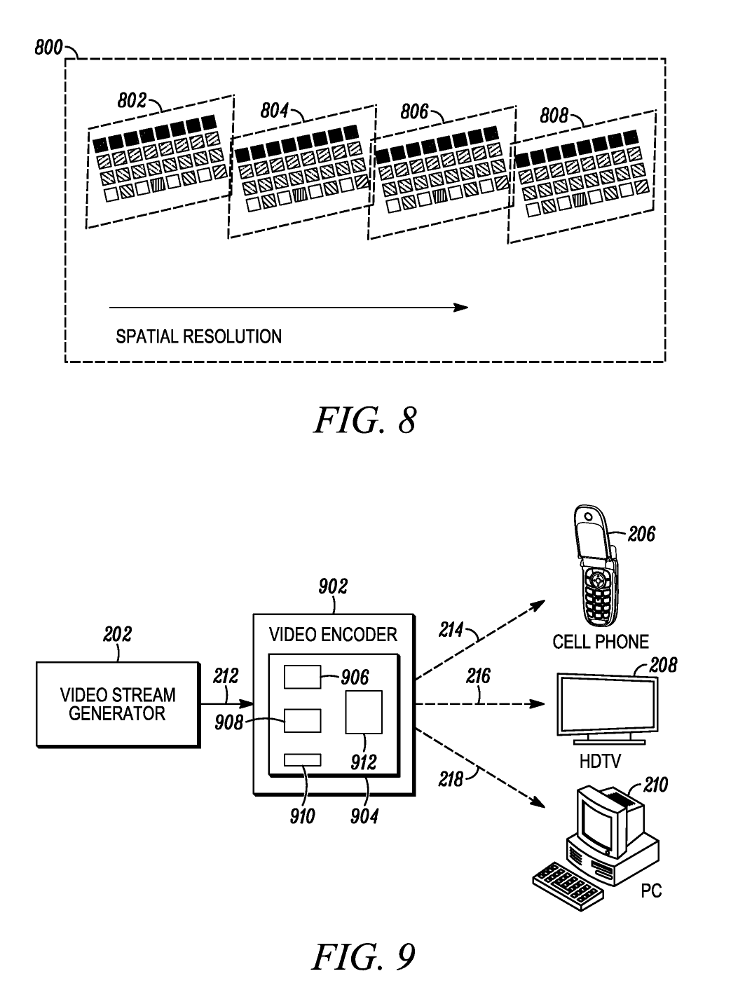

Extracting portion 912 can extract a frame from the plurality of frames based on the inclusion boundary. As will be discussed in more detail below, once an inclusion boundary of the substreams of varying spatial, temporal, and quality levels is established (based on the estimated distortion), extracting portion may extract that frames that lie outside of the inclusion boundary. This specific frame selection in accordance with an aspect of the present invention is distinct from the frame selection based on a rigid spatial, temporal or quality level, as discussed above with reference to FIGS. 6-8.

As illustrated in the figure, frame generating portion 906, distortion estimating portion 908, inclusion determining portion 910 and extracting portion 912 are individual devices. In some embodiments, video encoder 902 may be implemented on a device that is operable to read a device-readable media having device-readable instructions stored thereon, wherein the device-readable instructions are capable of instructing the device to operate in the manner discussed herein.

In some embodiments, at least two of frame generating portion 906, distortion estimating portion 908, inclusion determining portion 910 and extracting portion 912 are a unitary device. Further, in some embodiments, at least two of video encoder 902 may be implemented on a device that is operable to read a device-readable media having device-readable instructions stored thereon, wherein the device-readable instructions are capable of instructing the device to operate in the manner discussed herein.

In some embodiments, a bit stream extractor 904 is not within a video encoder. In such embodiments, a distinct video encoder is able to first encode an entire set of substreams of varying spatial, temporal, and quality levels. The distinct video encoder may then provide the entire set of substreams to a separate distinct bit stream extractor in accordance with an aspect of the present invention.

A more detailed discussion of example embodiments of a video encoder in accordance with the present invention will now be described.

Suppose that a video provider wants to provide a video having a predetermined guaranteed quality. In other words, the video provider wants to provide a video having a predetermined acceptable (maximum) distortion. In accordance with an aspect of the present invention, a video encoder may determine a specific video stream that will provide a maximum bit rate for transmission for a predetermined acceptable distortion.

Referring to FIG. 9, say for example, that a video provider wants to provide a video such that the predetermined acceptable distortion in the received video signal at the receiver is Xₘₐₓ. As will be discussed in greater detail below, video encoder 902 may determine the video stream associated with a maximum bit rate for transmission that will guarantee that the received video will encounter no more than Xₘₐₓ distortion. Presume in this example that in order to guarantee that the received video will encounter no more than Xₘₐₓ distortion, only transmission bit rates associated with channel 216 and channel 218 may be used. In such a case, cell phone 206 would not be able to receive the transmitted signal. However, HDTV 208 and PC 210 would receive the signal with a distortion that is no more than Xₘₐₓ.

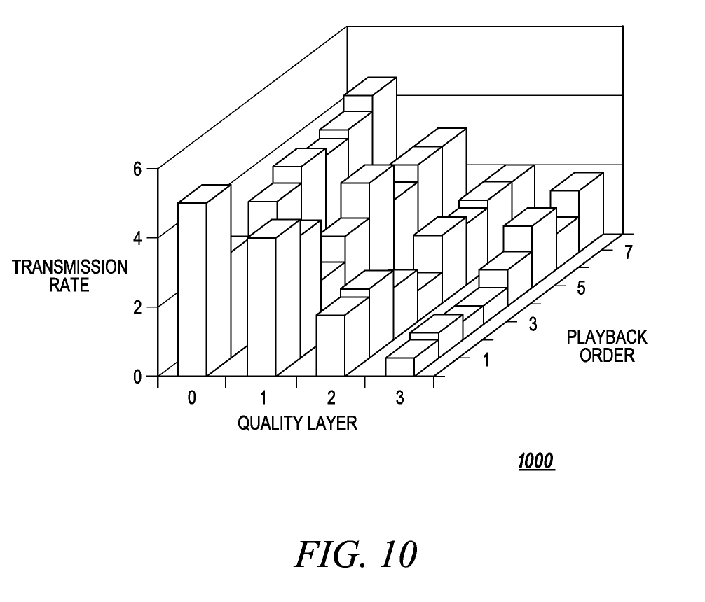

A case of extracting a substream with the maximum bit rate for a predetermined acceptable (maximum) distortion will be discussed, in accordance an aspect of the present invention will now be discussed below with reference to FIGS. 10-14.

FIG. 10 illustrates a graph 1000, which illustrates the transmission rate of each NAL unit in a single-resolution SVC bitstream as a function of its quality layer (x-axis) and its play backorder (y-axis).

In graph 1000, note that the NAL units in Quality Layer 0 have a higher transmission rate than those in Quality Layer 1, and those NAL units in Quality Layer 1 have a higher transmission rate than those in Quality Layer 2, and so forth. This is because as more Quality Layers are included in the extracted substream, more NAL units need to be transmitted, therefore slowing down the transmission rate.

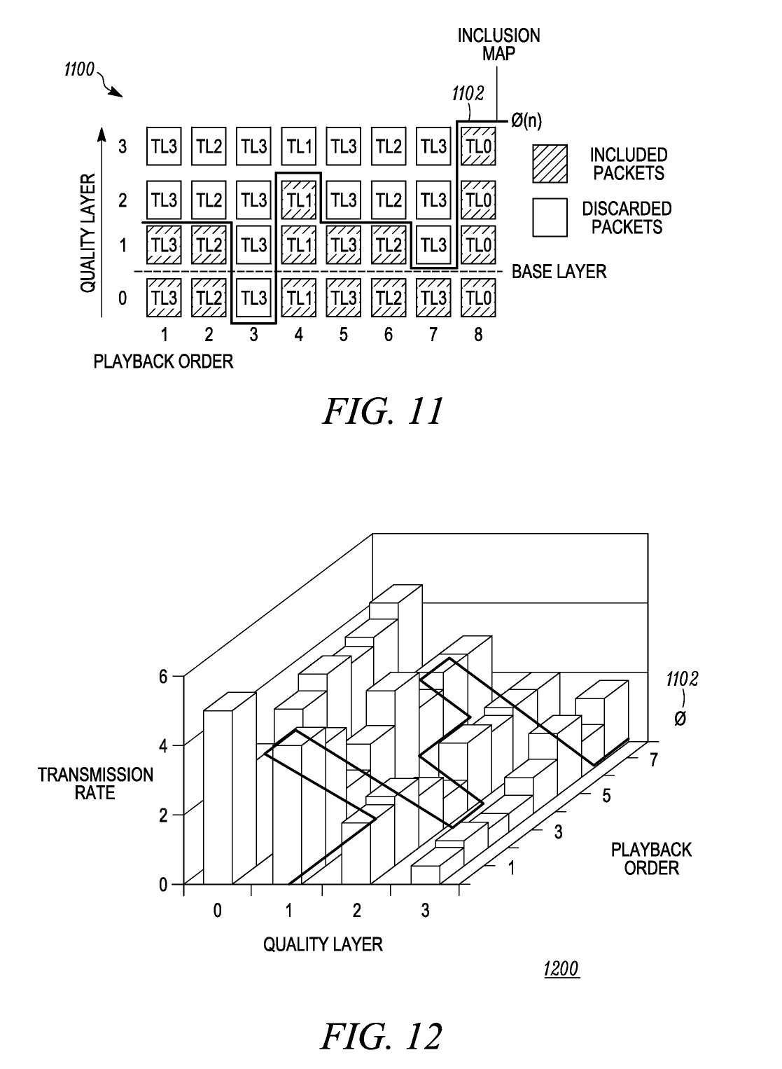

In accordance with an aspect of the present invention, the bit extraction algorithm determines the subset of NAL units that results in the maximum possible bit rate for a given acceptable distortion, using the transmission rates for each NAL as shown in FIG. 10. Unlike conventional methods, the selection of NAL units to be included is not limited to entire layers. The selected NAL units to be included in the bit-stream form an inclusion map, as shown in FIG. 11.

FIG. 11 illustrates an example inclusion map 1100 showing the selection of NAL units in a single-resolution SVC bitstream, in accordance with an aspect of the present invention. Inclusion map 1100 includes an inclusion border 1102, which determines which NAL units are to be included in the substream (grey boxes) and which are to be excluded (white boxes). Note that unlike conventional bit stream extraction methods, the selection of NAL units is not limited to entire temporal/spatial/quality layers; for example, not all NAL units in Quality Level 1 are included, as NAL units corresponding to playback order 3 and 7 are excluded. Here, the bit stream extractor algorithm takes into account the content of each NAL unit and its specific contribution to the resulting substream; if omitting a NAL unit can increase the resulting transmission rate without significantly increasing the distortion of the resulting video sequence, it will be excluded.

FIG. 12 includes a graph 1200, which illustrates graph 1000 with the addition of the inclusion border 1102, indicating the NAL units that are included in the extracted substream. Note that excluded NAL units are all of relatively slow transmission rates, since the bit stream extractor algorithm has determined that by discarding those NAL units, the overall bit rate can be increased without affecting the resulting distortion of the substream. In this manner, a substream can be optimally extracted in order to maximize the resulting bit rate.

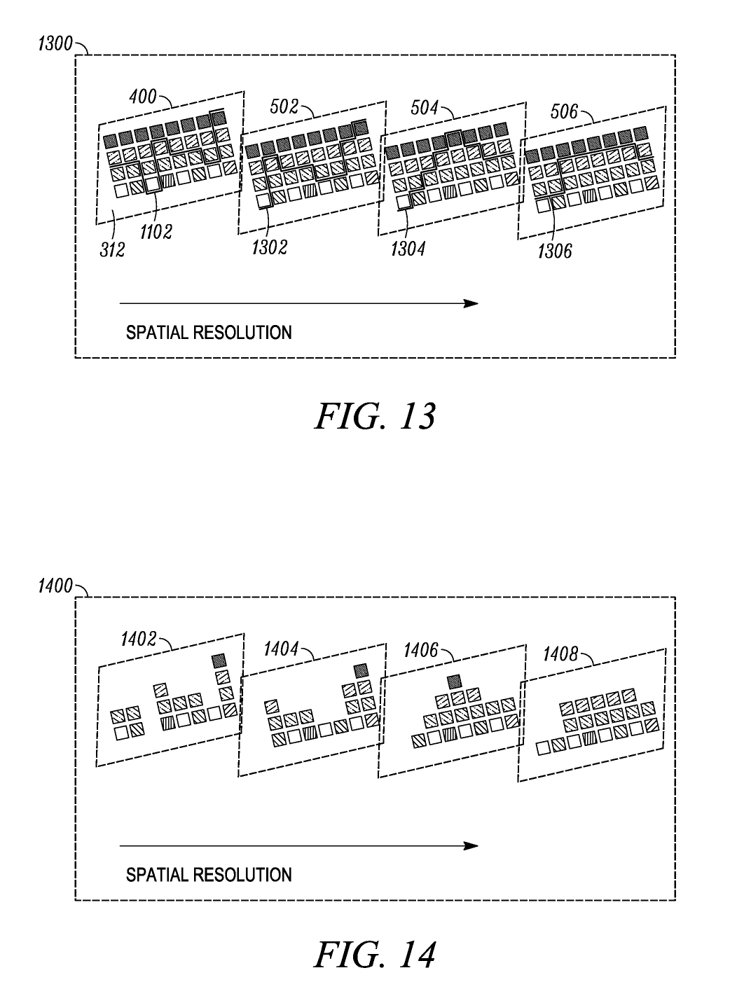

Note that the graph of FIG. 10, the inclusion map of FIG. 11 and the resulting graph of FIG. 12 are for an SVC bitstream of a fixed spatial resolution; however, in accordance with an aspect of the present invention, the bit stream extraction method can be extended to SVC bitstreams with varying spatial layers. This is done by considering each spatial layer individually, and then by imposing a restriction that all quality NAL units associated with lower resolution spatial layers are to be included before the base quality of a higher spatial resolution. Each spatial layer will then have its own inclusion map as in FIG. 11. This will be shown in detail below in reference to FIGS. 13 and 14.

FIG. 13 shows a diagram of a full bitstream 1300 with four spatial layers with example inclusion maps drawn for each spatial layer. Full bitstream 1300 includes blocks 400, 502, 504, and 506, and inclusion borders 1102, 1302, 1304 and 1306.

Note that inclusion border 1102 drawn on block 400 is the same as that shown in FIG. 11. Block 400 is the base spatial layer of full bitstream 1300. Block 502, since it is of a different spatial resolution, has its own, different inclusion border 1302. Similar cases exist for blocks 504 and 506.

FIG. 14 illustrates an extracted substream 1400 based on the inclusion maps drawn for full bitstream 1300 of FIG. 13. Substream 1400 includes four spatial layers, blocks 1402, 1404, 1406, and 1408.

Blocks 1402, 1404, 1406, and 1408 correspond to blocks 400, 502, 504, and 506 of full bitstream 1300, except now in each block only the NAL units designated to be included by their respective inclusion borders remain. In this manner, substream 1400 has been extracted from full bitstream 1300, by the use of inclusion maps based on the maximization of the transmission rate of the included NAL units.

Note that the bit stream extraction method of the present invention (as illustrated in FIGS. 13 and 14) is very different from the conventional methods of extracting SVC bit streams (as illustrated in FIGS. 6-8), which do not optimally select individual NAL units to maximize the resulting transmission rate of the extracted bitstream.

Now suppose that a video provider wants to provide a video stream having a minimized distortion for a given transmission bit rate. In other words, the video provider wants to provide a video, knowing that the transmission rate is limited to a fixed transmission bit rate. In this case, the video provider wants to minimize distortion. In accordance with an aspect of the present invention, a video encoder may determine a video stream that will determine a minimum distortion for a fixed bit rate of transmission.

Referring to FIG. 9, say for example, that a video provider wants to provide a video to cell phone 206, HDTV 208 and PC 210. Presume that channel 214 is has the lowest bit rate of transmission. Accordingly, in order to provide a video to cell phone 206, HDTV 208 and PC 210, lowest bit rate of transmission, will be the limiting factor. Accordingly, the bit rate of transmission of channel 214 will be the limiting factor to determine the minimum distortion. As will be discussed in greater detail below, video encoder 902 may determine a video stream that will encounter a minimum distortion during transmission for the fixed bit rate of transmission.

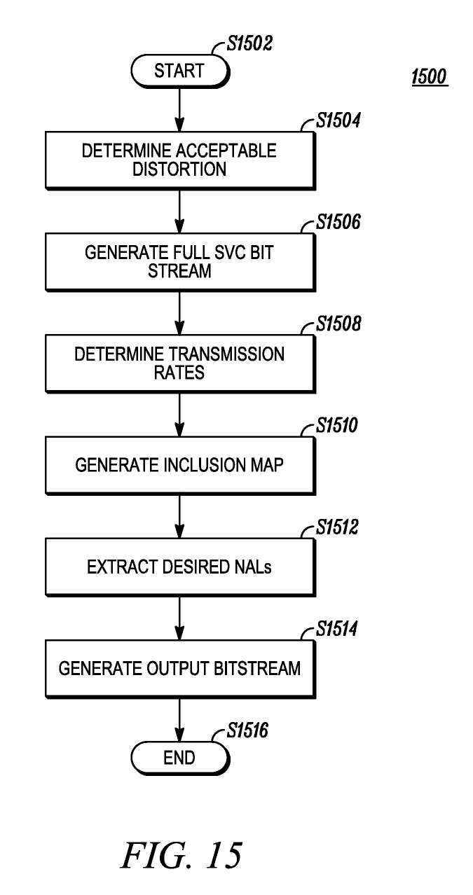

An example method of bit stream extraction to maximize transmission rate for a given distortion in accordance with an aspect of the present invention will now be described with reference to FIG. 15.

Method 1500 starts (S1502) and the acceptable (maximum) distortion is determined (S1504). This determination may be made by the system operator.

For example, with reference to FIG. 9, the acceptable distortion to be used by inclusion determining portion 910 may be very small, which would result in a relatively high required transmission rate. In such a case, channel 216 to HDTV 208 would be able to support a resulting video stream because channel 216 may have an extremely large bandwidth. Accordingly, HDTV 208 would be able to provide a video that is relatively distortion free. However, it would be unlikely that channel 214 to cell phone 206 would be able to support a resulting video stream because channel 214 may have bandwidth that is drastically smaller than that of channel 216.

On the other hand, the acceptable distortion to be used by inclusion determining portion 910 may be very large, which would result in a relatively low required transmission rate. In such a case, channel 216 to HDTV 208 and channel 214 to cell phone 206 would be able to support a resulting video stream. However, the resulting video stream provided to either device may have much distortion.

In light of the two examples discussed above, it is clear that the level of acceptable distortion may be adjusted to accommodate an intended transmission rate.

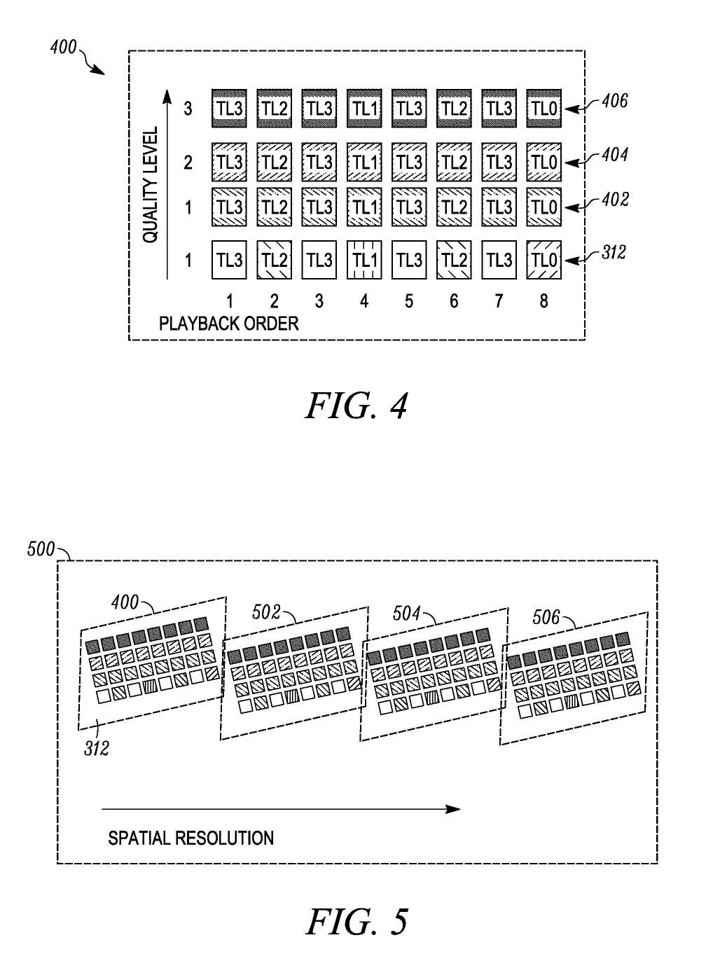

Once the acceptable distortion is determined, the full SVC bitstream (including all temporal, quality, and spatial layers) is generated (S1506). An example of which is full bitstream 500 shown in FIG. 5. In some embodiments, for example in the case where a bit stream extractor is a separate device from a video encoder, the term “generated” may described as the full SVC bitstream being provided to the bit stream extractor.

Then the transmission rate of each NAL unit in the full SVC bitstream is determined (1508), as illustrated in FIG. 10. This will be described in more detail below.

With this information, the optimal subset of NAL units resulting in the maximum transmission rate for a given distortion is determined, and an inclusion map for each spatial layer is generated (S1510), as shown in FIG. 10 and FIG. 13. In some embodiments, this inclusion map take into account the amount of packet loss of the transmission channel. Still further, in some embodiments, this inclusion map may take into account the packet loss gradient of the transmission channel. Establishment of the inclusion map will be described in greater detail below.

Then the desired NAL units (as indicated by the inclusion maps) are extracted (S1512), and the output bitstream is generated (S1514). An example of an extracted substream is illustrated in FIG. 14. After this, method 1500 ends (S1516).

In method 1500, the acceptable (maximum) distortion is determined (S1504) before the full SVC bitstream is generated (S1506). However, in other example embodiments, the full SVC bitstream may be generated (S1506) before the acceptable (maximum) distortion is determined (S1504).

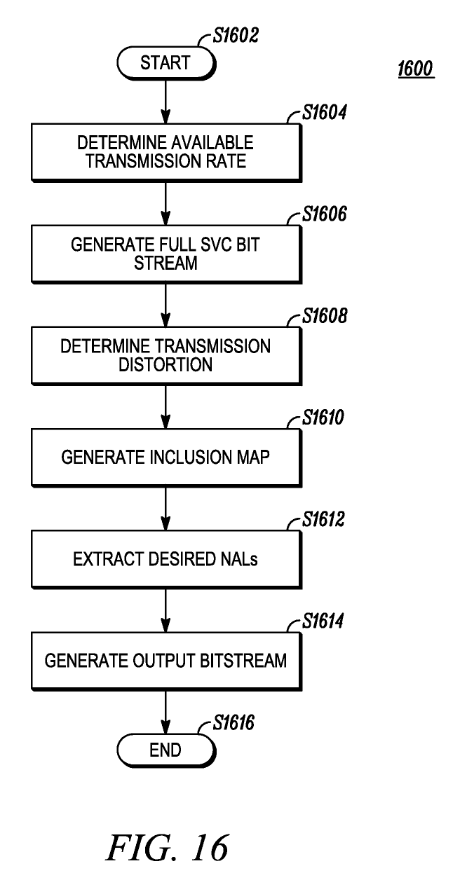

So far the case of extracting a substream in order to maximize the overall bit rate for a given acceptable distortion has been discussed. The case of extracting a substream in order to minimize distortion for a given bit rate will be now be discussed. The extraction method is similar in that the content of each individual NAL unit is considered and inclusion maps for each spatial layer are drawn to extract the most optimal substream. The inclusion map for each spatial layer is chosen based on the specific subset of NAL units that would result in the least distortion for a given bit rate. An example method of bit stream extraction to minimize distortion for a given bit rate in accordance with an aspect of the present invention will now be described with reference to FIG. 16.

Method 1600 starts (S1602) and the available transmission bit rate is determined (S1604).

Referring to FIG. 9, suppose for example that the video provider want to send a video to each of cell phone 206, HDTV 208 and PC 210. In this example, presume that channel 214 can support the lowest bit rate of transmission. In such a case, the video provider will be limited by the bit rate of transmission that is supportable by channel 214.

Once the available transmission bit rate is determined, the full SVC bitstream (including all temporal, quality, and spatial layers) is generated (step S1606). An example of which is full bitstream 500 shown in FIG. 5. In some embodiments, for example in the case where a bit stream extractor is a separate device from a video encoder, the term “generated” may described as the full SVC bitstream being provided to the bit stream extractor.

Then the expected distortion of the resulting video sequence of each possible substream (each possible set of NAL units) is determined (S1608). This will be described in greater detail below.

With this information, the subset of NAL units resulting in the minimum distortion for the given bit rate is determined, and an inclusion map for each spatial layer is generated (S1610). This will be describe in greater detail below.

Then the desired NAL units (as indicated by the inclusion maps) are extracted (S1612), and the output bitstream is generated (S1614). After this, method 1600 ends (S1616).

In method 1600, the available transmission bit rate is determined (S1604) before the full SVC bitstream is generated (S1606). However, in other example embodiments, the full SVC bitstream may be generated (S1606) before the available transmission bit rate is determined (S1604).

A more detailed explanation of the distortion estimation and minimization for optimal bit stream extraction in accordance with aspects of the present invention will now be provided.

As a substitute to the content-independent packet prioritization of conventional extraction methods, a rate-distortion optimized priority-based framework is employed. In such a framework, a priority is computed for a NAL unit, which represents a frame or a portion of a frame (i.e., residual frame) at a given spatio/temporal/quality level. Note that in this scheme, unlike the conventional basic extraction scheme, all pictures of a given layer do not necessarily follow the same prioritization order. In order to efficiently assign Quality Layers, NAL units have to be ordered according to their contribution to the overall quality of the video sequence. When the correct order is obtained, one can assign the Quality Layers to the NAL units either based on a quantization of their indices or based on an iterative merging algorithm. With a iterative merging algorithm, at each iteration the two adjacent quality increments with the minimum increase in the area below a R-D curve are selected and merged into one until the target number of Quality Layers are achieved.

Assuming an optimal order of the NAL units exists, it can be obtained if for any bit rate Rₘᵢₙ<R<Rₘₐₓ, an optimal subset of the available NAL units can be extracted. Here Rₘᵢₙ and Rₘₐₓ denote the minimum and maximum possible bit rates of the scalable bit stream, respectively. As a result, the problem of optimal extraction of a substream at a provided bit rate R is considered. Once the solution to this problem is obtained, one can easily order packets and assign Quality Layers.

Let π(n, d, q) represent the NAL unit associated with frame n at spatial resolution d and quality level q (q=0 represents the base quality). Then, any “consistent” subset of quality increments, P, can be uniquely identified by an inclusion map φ defined by

φ(n,d)=|Q(n,d)|, (1)

where Q(n, d):={q:π(n, d, q)εP} and the notation |•| represents the cardinality of a set. The term “consistent” here refers to a set whose elements are all decodable by the scalable decoder (children do not appear in the set without parents). Note that φ(n, d)=0 indicates that no NAL unit for frame n at resolution d has been included in the set. In this case, if d represents the base resolution, it is inferred that the base layer has been skipped and therefore the dependent frames are undecodable. An example of an inclusion map for a single resolution bit stream is discussed above with reference to FIG. 10.

The problem of optimal selection of the quality increments with a target rate of R_{T} can be formulated as

$${φ}^{*} arg {min}_{φ ∈ φ} D ( φ ) , s . t . R ( φ ) \leq {R}_{T} , \qquad ( 2 )$$

where φ is a vector with elements φ(n,d) for all possible n and d. Furthermore, R(φ) and D(φ) denote the average bit rate and distortion of the video sequence computed using the substream associated with selection map φ. Here, φ represents the set of all possible selection maps for which the resulting substream is decodable. In an example embodiment of the present invention, the distortion D is calculated using the mean squared error (MSE) metric with respect to the fully reconstructed video sequence (maximum quality). Note that for most applications, bit extraction is a post-processing operation, and thus the original video signal is not available for quality evaluation.

In principle, a solution to equation (2) can be found using a non-linear optimization scheme. Nevertheless, in order to converge to a solution, many evaluations of the objective function D(φ) are necessary. Unfortunately, because of various spatio/temporal dependencies, each evaluation of D(φ) requires performing motion compensation operations on several images (due to the hierarchical prediction structure) in addition to the computation cost for finding the MSE. Furthermore, motion compensation operations are known to be highly computationally intensive. Therefore, the computational burden of this optimization is unmanageable in practice. In order to overcome this difficulty, a computationally efficient model that provides an accurate estimate of the source distortion for any selection map φεΦ is provided.

As discussed previously, fast evaluation of the average sequence distortion plays an essential role in solving the optimization problem of equation (2). An aspect of the present invention provides an approximation method for the computation of this distortion. The examples discussed will be based on a single-resolution SVC stream. Nonetheless, the calculations can be directly applied to the more general multi-resolution case by imposing the constraint that all quality NAL units associated with lower resolution spatial layers are included before the base quality of a higher resolution. This constraint reduces the degrees of freedom associated with the selection function by one. Hence, it can be denoted by φ(n) since the spatial resolution d in φ(n,d) is fixed. Note that regardless of the number of spatial layers in the SVC bitstream, a target resolution has to be specified in order to evaluate the quality of the reconstructed sequence. The quality increments from spatial layers lower than the target resolution need to be up-sampled to the target resolution to evaluate their impact on the signal quality. Once again it shall be mentioned that throughout the example embodiments discussed herein, the video quality is measured with respect to the fully reconstructed signal.

The base layer of a picture usually contains motion vectors and a coarsely quantized version of its residual signal required for the construction of (at least) a low quality representation of the picture. In addition, for this reconstruction, the decoder also requires the base layer of the pictures used in the prediction of the current picture. Hence, two different distortion models are proposed, based on the status of the base layers. In the first model, the base layer of the frame is available and decodable by the decoder. In the second model, the base layer is either not available or undecodable due to loss of a required base layer. In the second model, an error concealment strategy may be employed, which includes some special considerations.

Since for MGS coding of SVC, motion compensated prediction is conducted using the highest available quality of the reference pictures (except for key frames), propagation of drift has to be taken into account whenever a refinement packet is missing. Let fₙ^{d} and fₙ denote a vector representation of the reconstructed n-th frame using all of its quality increments in presence and absence of drift, respectively. Note that although all quality increments of frame n are included for the reconstruction of both fₙ and fₙ^{d}, fₙ^{d}≠fₙ since in general some quality increment of the parent frames may be missing in the reconstruction of fₙ^{d}. Moreover, let eₙ(q) represent the error vector introduced by the inclusion of q≦Q quality increments for the n-th frame when no drift exists. This error is referred to as the EL truncation error. Here, Q represents the total number of quality levels (in all layers), hence, eₙ(q)=0.

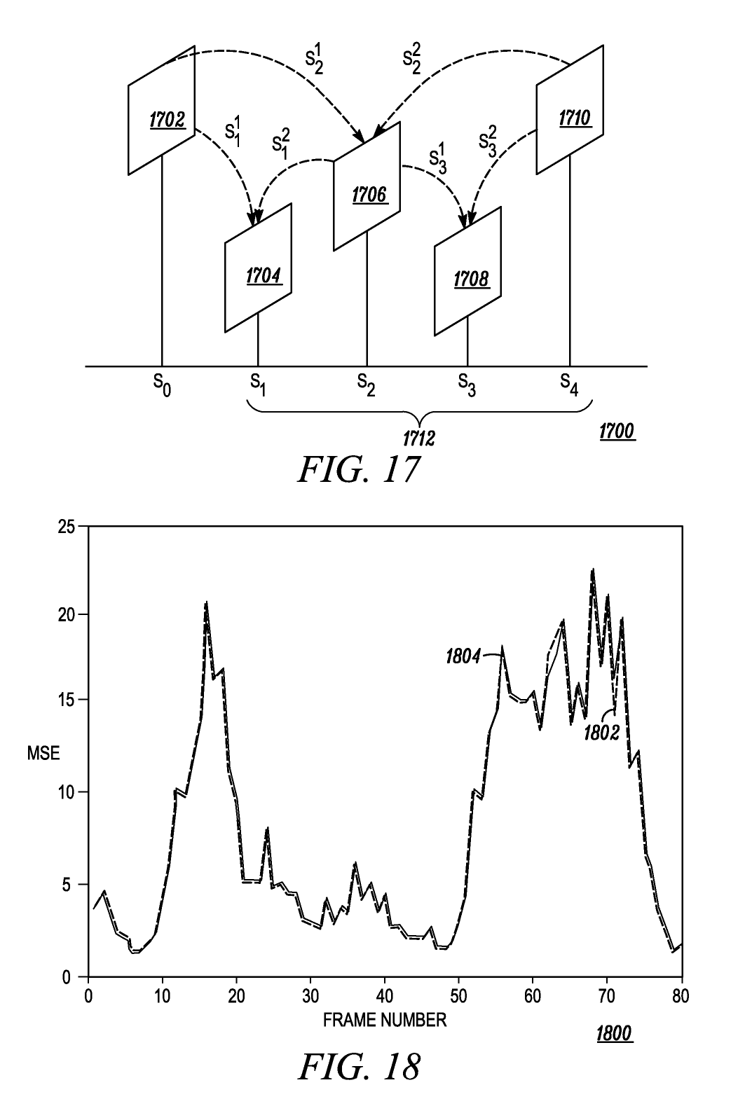

The total distortion of frame n due to drift and EL truncation (i.e., Dₙ^{t}) with respect to fₙ is obtained according to

$$\begin{matrix}{D}_{n}^{t} ( q ) = {‖ {f}_{n} - {f}_{n}^{d} + {e}_{n} ( q ) ‖}^{2} \\ = {D}_{n}^{d} + {D}_{n}^{e} ( q ) + 2 {( {f}_{n} - {f}_{n}^{d} )}^{T} {e}_{n} ( q ) ,\end{matrix} \qquad ( 3 )$$

where Dₙ^{d} and Dₙ^{s}(q) represent respectively the distortion, i.e., sum of squared errors (SSE), due to drift and EL truncation (associated with the inclusion of q quality increments). The symbol ∥•∥ here represents the l₂-norm. Since the Cauchy-Schwartz inequality provides an upper bound for equation (3) the total distortion Dₙ^{t} can be approximated as

$${D}_{n}^{t} ( q ) \approx {D}_{n }^{d} + {D}_{n}^{e} ( q ) + 2 κ \sqrt{{D}_{n}^{d}} \sqrt{{D}_{n}^{e} ( q )} \leq {D}_{n}^{d} + {D}_{n}^{e} ( q ) + 2 \sqrt{{D}_{n}^{d}} \sqrt{{D}_{n}^{e} ( q )} , \qquad ( 4 )$$

where k is a constant in the range 0≦k≦1 obtained experimentally from test sequences. Consequently, in order to calculate the total distortion, the drift and EL truncation distortions, Dₙ^{d} and Dₙ^{s}(q), respectively, are needed. Fortunately, the error due to EL truncation, Dₙ^{s}(q), can be easily computed either at the encoder when performing the quantization of the transform coefficients or by a post-processing operation. The drift distortions, on the other hand, depend on the computationally intensive motion compensation operations and propagate from a picture to its descendants. The parent-child relationship of pictures within a GOP will now be discussed in reference to FIG. 17.

FIG. 17 shows a diagram 1700 illustrating the parent-child relationships for an example GOP of size 4. Diagram 1700 includes picture s₀ 1702, picture s₁ 1704, picture s₂ 1706, picture s₃ 1708, and picture s₄ 1710. GOP 1712 includes picture s₁ 1704, picture s₂ 1706, picture s₃ 1708, and picture s₄ 1710.

As shown in FIG. 17, picture S₂ 1706 is considered a child of pictures s₀ 1702 and s₄ 1710 since it is bi-directionally predicted from them. Therefore, a distortion in any of the parent frames (s₀ 1702 and s₄ 1710), will induce a distortion in the child frame (s₂ 1706). Further, picture s₃ 1708 is considered a child of picture S₂ 1706 and picture s₄ 1710, since it is bi-directionally predicted from them. Thus a distortion in picture s₀ 1702 would not only induce distortion in child picture s₂ 1706, but also to picture s₃ 1708.

Let the set S={s₀, s₁, . . . s_{N}} represent the N pictures in the GOP plus the key picture of the preceding GOP denoted by so as portrayed in FIG. 17 (for N=4). Let Λₓ represent the set of parent frames associated with frame sₙ. Hence, the set Λₙ, is either empty (for key frames) or has exactly two members, referred to as sₙ¹ and sₙ². For instance, the parent set for frame s₂ 1706 in FIG. 17 equals Λ₂={s₀,s₄}. Further, let Dᵢ^{t} represent the total distortion of a parent frame of sₙ, i.e., iεΛₙ. Then, it can be assumed that the drift distortion inherited by the child frame, denoted as Dₛ_{ₙ}^{d} or simply Dₙ^{d}, is a function of parent distortions, i.e.,

$${D}_{n}^{d} = F ( {D}_{{s}_{n}^{1}}^{t} , {D}_{{s}_{n}^{2}}^{t} ) .$$

Therefore, an approximation to D_{d}ⁿ can be obtained by a second order Taylor expansion of the function F around zero

Dₙ^{d}≈γ+Σ_{iεΛ}_{ₙ}αᵢDᵢ^{t}+Σ_{i εΛ}_{ₙ}Σ_{jεΛ}_{ₙ}βᵢⱼDᵢ^{t}Dⱼ^{t}. (5)

Here the coefficients αᵢ and βᵢⱼ are first and second order partial derivatives of F at zero and are obtained by fitting a 2-dimensional quadratic surface to the data points acquired by the decodings of the frames with various qualities. The constant term γ=0, since there is no drift distortion when both reference frames are fully reconstructed, i.e., Dᵢ^{t}=0, i=1,2.

Note that technically,

$$F ( {D}_{{s}_{n}^{1}}^{t} , {D}_{{s}_{n}^{2}}^{t} )$$

is not a function since the mapping

$$\{ {D}_{{s}_{n}^{1}}^{t} , {D}_{{s}_{n}^{2}}^{t} \} > {D}_{n}^{d}$$

is not unique because distortions may be due to various error distributions. Therefore, equation (5) can only be justified as an approximation since the errors arising from missing high frequency components are usually widespread throughout the image and follow similar distributions. The coefficients of equation (5) for all frames except key frames, can be obtained by several decodings of different substreams extracted from the global SVC bit stream. Nevertheless, different methods for choosing the data points may exist. For instance, a suitable set of data can be computed using the following steps: first, for each temporal layer T, a random set of the quality increments are discarded from frames in temporal layers T and lower, while keeping all quality increments of the higher layers (to eliminate EL truncation distortion); and second, the resulting bit stream is decoded and all data points are collected: distortion of each frame n in a temporal layer higher than T along with the distortion of the parent frames (which belong to layers T or lower) form a data point

$$\{ {D}_{n}^{d} , {D}_{{s}_{n}^{1}}^{t} , {D}_{{s}_{n}^{2}}^{t} \}$$

for that frame.

Once the coefficients αᵢ and βij are computed for each frame (except for key frames), the drift distortion of the child frame Dₙ^{t} can be efficiently estimated for various distortions of the parent frames. The total distortion Dₙ^{t} is then computed according to equation (4). The computed distortion of this frame is then used (as a parent frame) to approximate the drift distortion of its children. Therefore, the distortion of the whole GOP can be estimated recursively starting from the key frame, which is not subject to drift distortion. An example calculation of estimated distortion in accordance with an aspect of the present invention will now be discussed with reference to FIG. 18.

FIG. 18 shows a graph 1800 illustrating the comparison between the estimated versus the actual distortion for a random selection map of the Foreman CIF sequence. Graph 1800 includes function 1802 and function 1804. The y-axis is mean-squared error (MSE) and x-axis is the frame number.

In graph 1800, function 1802 (dotted line) is the estimated distortion for each frame calculated according to equation (5), in accordance with an aspect of the present invention. Function 1804 (solid line) is the actual distortion for each frame. Note that function 1802 closely matches function 1804. Therefore, it can be assumed that the estimation of distortion as discussed in reference to equation (5) is fairly accurate.

In accordance with aspects of the present invention, in addition to the enhancement layer NAL units, base layer NAL units are allowed to be skipped when resources are limited. Moreover, base layer NAL units may be damaged or lost in the channel and therefore would become unavailable to the decoder. In this scenario, all descendants of the frame to which the NAL unit belongs to are also discarded by the decoder. Consequently, the decoder utilizes a concealment technique as an attempt to hide the lost information from the viewer. Here, a simple and popular concealment strategy is employed: the lost picture is replaced by the nearest temporal neighboring picture. To be able to determine the impact of a frame loss on the overall quality of the video sequence, the distortion of the lost frame after concealment needs to be computed.

Let D_{n,i}^{con} denote the distortion of a frame n concealed using frame i with a total distortion of Dᵢ^{t}. Since D_{n,i}^{con} does not vary greatly with respect to Dᵢ^{t}, it can be assumed that a linear relationship exists between them, i.e.,

D_{n,i}^{con}≈μᵢ+νᵢDᵢ^{t}, (6)

where μᵢ and νᵢ are constant coefficients calculated for each frame with all concealment options (different i's). For example in diagram 1700 of FIG. 17, the concealment options for picture s₃ 1708, in the preferred order, are {s₂, s₄, s₀}. In an example embodiment, the coefficients in equation (6) are obtained by conducting a linear regression analysis on the actual data points. Note that these data points are acquired by performing error concealment on frames reconstructed from decodings explained previously. Hence, no extra decoding is required for this process.

During optimization, whenever a frame is skipped or missing, the pre-calculated coefficients μᵢ and νᵢ, associated with the nearest available temporal neighbor i (which has a distortion Dᵢ^{t}), are used according to equation (6) to estimate the distortion of the missing frame.

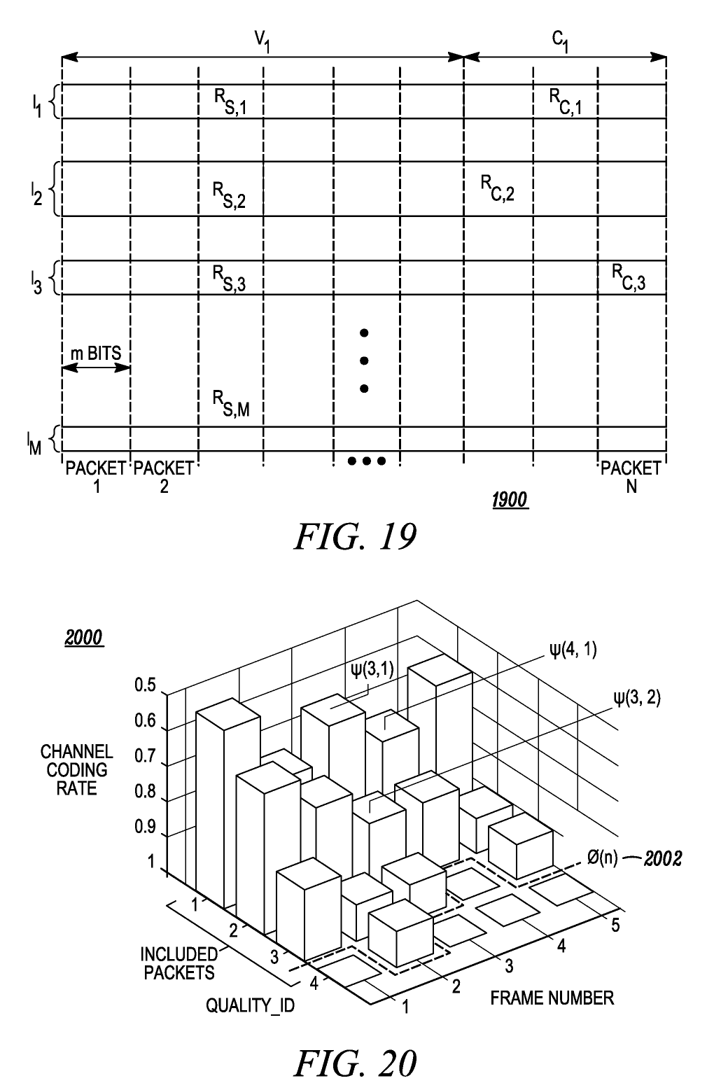

As briefly mentioned earlier, there is the possibility that NAL units may become damaged or lost in transmission. Therefore, the distortion of the video sequence at the decoder consists of transmission errors in addition to the aforementioned distortion due to quantization degradation. Consequently, an efficient and robust video communication system requires a circumspect combination of source optimization techniques that are well-integrated with error control techniques. In accordance with an aspect of the present invention, methods to account for errors resulting from transmission over packet loss networks are implemented in the bit stream extraction algorithm. These will now be discussed below with references to FIGS. 19-20.

FIG. 19 includes a diagram 1900, which demonstrates the packetization scheme for NAL units. Here, a source packet consists of a SVC NAL unit and is portrayed as a row in diagram 1900. Each column, on the other hand, corresponds to a transport layer packet. The source bits and parity bits for the k-th source packet are denoted by R_{s,k} and R_{c,k}, respectively. The source bits, R_{s,k}, are distributed into νₖ transport packets and the redundancy bits, R_{c,k}, are distributed into the remaining cₖ transport packets. If a symbol length of m bits is assumed, the length that the k-th source packet contributes to each transport packet can be obtained by

$${l}_{k} = \frac{{R}_{s , k}}{{mv}_{k}} .$$

Furthermore, channel coding of each source packet is carried out by an RS(N, νₖ) code, where N indicates total number of transport packets. Therefore, the loss probability of each source packet is given by

$${p}_{k} = 1 - {\sum }_{i = 0}^{t} ( \begin{matrix}i \\ N\end{matrix} ) {{ε}^{i} ( 1 - ε )}^{N - i} , \qquad ( 7 )$$

where, ε denotes the transport packet loss probability and t=N−νₖ is the maximum number of transport packet losses allowed in order to recover the source packet.

As previously discussed in reference to equation (2), an inclusion function φ is obtained by minimizing the distortion of the extracted video substream for a given bit rate. However, in the presence of packet losses and errors during bit stream transmission, the task of channel coding should also be considered. Further, what should be minimized is the expected distortion of the extracted substream, since the actual distortion cannot be precisely determined due to errors and losses.

In accordance with an aspect of the present invention, the problem of joint source extraction and channel rate allocation may be formulated as follows. Let ψ(n,d,q) denote channel rate allocation associated with NAL unit π(n,d,q). Then, the optimal inclusion and channel rate functions are obtained by

$$( {φ}^{*} , {ψ}^{*} ) = {min}_{φ ∈ Φ , ψ ∈ Ψ} E \{ D ( φ , ψ ) \} \\ s . t . R ( φ , ψ ) \leq {R}_{T} , \qquad ( 8 )$$

where, ψ* is a matrix with elements of ψ(n,d,q) and Ψ is the set of all possible channel coding rates. Here, due to indeterministic nature of channel losses an expected distortion measure, E{D(φ,ψ)} is assumed for video quality evaluation. Note that the variables φ(n,d) and ψ(n,d,q) are dependant variables since the channel coding rate of a packet not included for transmission, is always equal to 1. In other words, for any possible n and d, there should be ψ(n,d,q)=1 for all q>φ(n,d). An example of inclusion and channel coding rate functions for a single resolution bit stream as determined by equation (8) will now be discussed with reference to FIG. 20.

FIG. 20 shows a graph 2000, which illustrates an example of inclusion and channel coding rate functions for a single resolution bit stream. The x-axis is the frame number, y-axis is quality layer, and z-axis is the channel coding rate. Graph 2000 includes an inclusion function φ(n) 2002.

As shown in graph 2000, inclusion function φ(n) 2002 delineates which packets are to be included in the extracted substream. Note that for all excluded packets, ψ(n,d,q)=1, since those packets will not be transmitted.

As mentioned previously, for applications in which transmission over a packet loss network is required, an expected distortion measure should to be considered to evaluate the video quality at the encoder. For these applications, a method is provided to estimate the overall expected distortion of the decoder for the given channel with available Channel State Information (CSI) and error concealment method. In an example embodiment, in accordance with an aspect of the present invention, the expected distortion of a GOP is calculated based on the inclusion function φ(n) of the GOP. As mentioned previously, for the general case, φ(n) specifies number of packets to be sent per frame n. The calculations to follow only account for single resolution bit streams; however, this technique can be applied to the general case if it is assumed the quality increments of lower spatial layers always appear before quality increments of current spatial layer. With this assumption, a 1-dimensional inclusion function φ(n) can describe a substream of the scalable bit stream.

For the following calculations of expected distortion, a generic case is considered, where a packet loss probability of pₙ^{q} is assigned to the qth quality level packet of frame n. Let \tilde{D}ₙ denote the distortion of frame n as seen by the encoder, i.e., \tilde{D}ₙ represents a random variable whose sample space is defined by the set of all possible distortions of frame n at the decoder. Then, assuming a total number of Q quality levels exist per frame, the conditional expected frame distortion E{\tilde{D}ₙ|BL} given that the base layer is received intact, may be obtained by

$$E \{ {\tilde{D}}_{n} \vert BL \} = {\sum }_{q = 1}^{φ ( n )} {p}_{n}^{q} {D}_{n} ( q - 1 ) {\sum }_{i = 0}^{q - 1} ( 1 - {p}_{n}^{i} ) + {D}_{n} ( φ ( n ) ) {\prod }_{i = 0}^{φ ( n )} ( 1 - {p}_{n}^{i} ) , \qquad ( 9 )$$

where, Dₙ(q) is the total distortion of frame n reconstructed by inclusion of q>0 quality increments (the superscript t of D is omitted for simplicity).

The first term in equation (9) accounts for cases in which, all (q−1) quality segments have been successfully received but the qth segment is lost, therefore, the reconstructed image quality is Dₙ(q−1). The second term accounts for the case where all quality increments in the current frame sent by the transmitter (given by φ(n)) are received. Recall that Dₙ(q) depends on the distortion of the parent frames according to equations (4) and (5) for the cases in which base layer is available and decodable. Unlike these source distortion calculations, exact distortions of the parent frames are not known by the encoder, therefore, Dᵢ^{t} in equation (5) has to be replaced with its expected value given the base layer, E{\tilde{D}ᵢ|BL} for all i ε{sₙ¹, sₙ²}. Similarly to previous calculations, the expected distortion of the each temporal layer, given the base layers, can be recursively computed starting with the lowest layer. Note that the lowest temporal layer (key frame) does not contain any drift distortions and hence its expected distortion can be computed by itself.

Due to the hierarchical coding structure of the SVC, decoding of the base layer of a frame not only requires the base layer of that frame but also the base layer of all the preceding frames in the hierarchy, which were used in prediction of the current frame. For instance, decoding any of the frames in the GOP demands that the key picture of the preceding GOP, s₀, be available at the decoder. For each frame sₙ εS, a set Δₙ can be formed consisting of all reference pictures in S that the decoder requires in order to decode a base quality of the frame. Note that for all n there is Λₙ⊂Δₙ. Further, in an attempt to better formulate the expected distortion for the general case, a relation≦is defined on the set Δₙ such that if x,y εΔₙ and x≦y then y depends on x (y is a descendent of x) due to motion-compensated prediction. It can be verified that set Δₙ plus the relation≦on the set, form a well-ordered set since all four properties, i.e., reflexivity, antisymmetry, transitivity, and comparability (trichotomy law) hold. Note that because all frames in the GOP depend on the key picture of the preceding GOP and no frame in Δₙ depends on frame sₙ, for all n≦N there is

s₀ [symbol] x,∀xεΔₙ(x)

sₙ [symbol] x,∀xεΔₙ(x) (10)

In the case that the base layer of any frame xεΔₙ is lost, the decoder is unable to decode frame n and therefore has to perform concealment from the closest available neighboring frame in display order. Consequently, the expected distortion of the frame n is computed according to

$$E \{ {\tilde{D}}_{n} \} = {\sum }_{i ∈ {Δ}_{n}} {p}_{i}^{0} {D}_{n , k}^{con} {\prod }_{{j ∈ {Δ}_{n}}_{j ≺ i}} ( 1 - {p}_{j}^{0} ) + E \{ {\tilde{D}}_{n} \vert BL \} {\prod }_{j ∈ {Δ}_{n}} ( 1 - {p}_{j}^{0} ) , \qquad ( 11 )$$

where, k represents the concealing frame, sₖ, specified as the nearest available temporal neighbor of i, i.e.,

$${s}_{k} = arg {min}_{{x ∈ {Δ}_{n}}_{x ≺ i}} \vert g ( x ) - g ( {s}_{n} ) \vert . \qquad ( 12 )$$

Here, g(x) indicates the display order frame number as defined before. The first term of equation (11) deals with situations in which the base layer of a predecessor frame i is lost (with probability pᵢ⁰) and thus frame n should be concealed using a decodable temporal neighbor while the second term indicates case in which all base layers are received. A final remark should be made regarding the computation of D_{n,k}^{con} based on equation (6). The distortion of frame sₖ given its base layer, referred to as Dₖ, may be needed in order to compute D_{n,k}^{con}. However, this distortion is a random variable and its exact value is unknown to the encoder. As a result, as before, its expected value E{\tilde{D}ₖ} is employed instead. The conditional expected distortions E{\tilde{D}ₙ|BL} should therefore be computed for each temporal layer (starting from the coarsest layer) before proceeding to calculations of unconditional expected values.

A challenge in solving the problem considered herein is the efficient evaluation of the sequence average quality for a provided mapping function φ(n) (see equation (2)) as discussed previously. Once the sequence average quality for any mapping function φ(n) is known, in theory, a nonlinear optimization scheme can be applied in order to find the best packet extraction pattern. In practice, however, careful consideration of the optimization method may be needed due to coarse-grain discrete nature of φ(n) and its highly complex relation to the overall distortion. Thus, in accordance with an aspect of the present invention, an example greedy algorithm is presented to efficiently find a solution to this problem.

The optimization can be performed over an arbitrary number of GOPs, denoted by M. Trivially, increasing the optimization window may result in a greater performance gain at a price of higher computational complexity. In the example algorithm in accordance with an aspect of the present invention, the base layer of the key pictures are given the highest priority and therefore are the first packets to be included. Then, packets are added one at a time based on their global distortion gradient. In other words, initially, the mapping function φ(n)=1 if sₙ is a key frame, otherwise φ(n)=0. Then, at each time step i, a packet π(nᵢ*, φ(nᵢ*)) is added and φ(nᵢ*) is incremented by one where nᵢ* is obtained by

$${n}_{i}^{*} = arg {min}_{n} \frac{\partial D ( φ ) / \partial φ ( n )}{\partial {R}_{s} ( φ ) / \partial φ ( n )} . \qquad ( 13 )$$

Here, Rₛ(φ) represents the source rate associated with the current mapping function φ. This process continues until the rate constraint R_{T} is met or all available packets within the optimization window (i.e., MGOPs), are added to the ordering queue.

Now the problem of equation (8) will be addressed. Here, an algorithm similar to the algorithm described for source-optimized bit extraction discussed earlier will be presented. Note that according to equation (9), the expected distortion of the video sequence directly depends on the source mapping function φ(n). Its dependency on packet channel coding rates, on the other hand, is implicit in that equation. The packet loss probabilities, pₙ^{q}'s, used in computation of the expected distortion depend on the channel conditions as well as the particular channel coding and rate employed.

Similar to the source optimization algorithm, an optimization window of M GOPs is considered here. The source mapping function φ(n) initially only includes the base layer of the key pictures with an initial channel coding rate less than 1. Then, at each time step, a decision is made whether to add a new packet to the transmission queue or increase the Forward Error Correction (FEC) protection of an existing packet. Let π(n*, q*) denote an existing packet (i.e., q*<φ(n*)) such that an increase in its channel protection results in the highest expected distortion gradient, δED*, obtained by

$$δ {ED}^{*} = {min}_{n} {min}_{q < φ ( n )} \frac{\partial ED ( φ , ψ ) / \partial ψ ( n , q )}{\partial {R}_{t} ( φ , ψ ) / \partial ψ ( n , q )} , \qquad ( 14 )$$

where, ED and Rₜ represent expected distortion and total rate associated with the current φ and ψ. Likewise, among candidate packets for inclusion, let π(n^{★}, q^{★}) denote the one with highest expected distortion gradient, δED^{★}, i.e.,

$$δ {ED}^{*} = {min}_{n} {min}_{ψ ( n , q ) ∈ Ψ} \frac{{\partial }^{2} ED ( φ , ψ ) / \partial φ ( n ) \partial ψ ( n , q )}{{\partial }^{2} {R}_{t} ( φ , ψ ) / \partial φ ( n ) \partial ψ ( n , q )} , \qquad ( 15 )$$

where, q=φ(n). In cases in which δED*<δED^{★}, the channel protection rate of the already included packet π(n*, q*) is incremented to the next level by padding additional parity bits. On the contrary, when δED*>δED^{★}, the source packet π(n^{★}, q^{★}) is included in the transmission queue with a channel coding rate ψ(n^{★}, φ(n^{★})) obtained from equation (15). Note that in both scenarios, the corresponding functions φ and ψ are updated according to the changes made to the transmission queue. This process is continued until the bit rate budget for the current optimization window R_{T} is reached.

The performance of the optimized bit extraction scheme for H.264/AVC SVC extension in accordance with an aspect of the present invention will now be evaluated. A simulation was implemented with the reference software Joint Scalable Video Model (JSVM) 9.10. Three video sequences (Foreman, City, and Bus) at display resolution of CIF are considered in the following experiments. Sequences are encoded into two layers, a base layer and a quality layer, with basis quantization parameters QP=36 and QP=24 respectively. Furthermore, the quality layers are divided into 5 MGS layers.

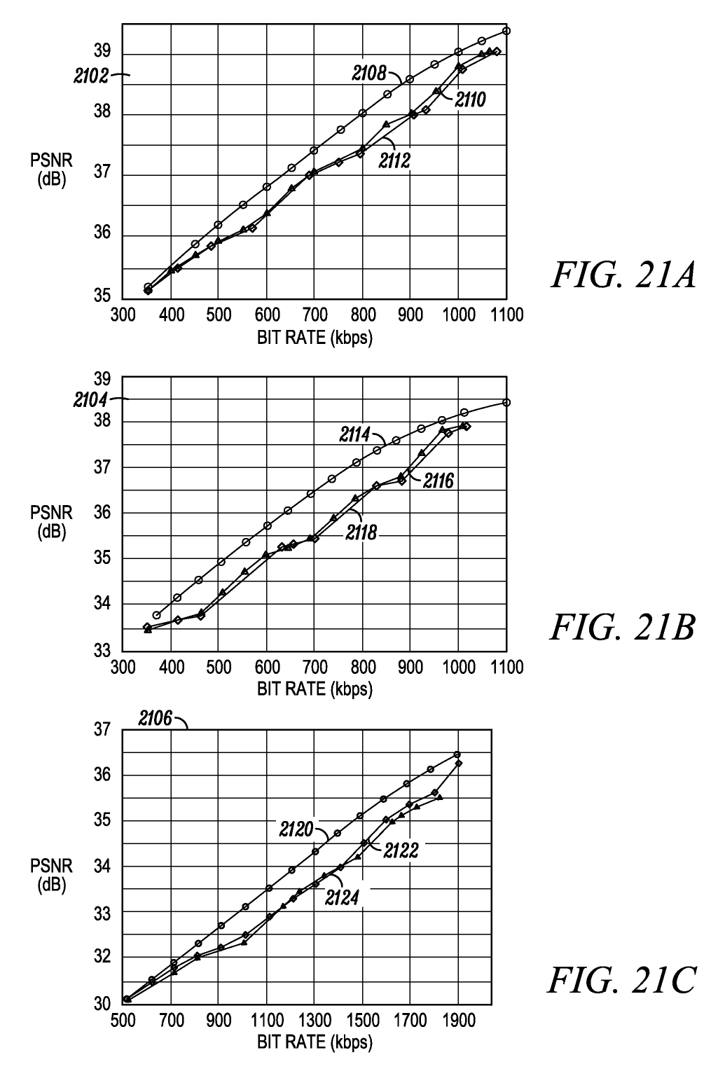

The source extraction scheme in accordance with an aspect of the present invention is compared to two conventional extraction approaches: 1) the JSVM optimized extraction with quality layers, referred to as “JSVM QL”, and 2) the content-independent JSVM basic extraction referred to as “JSVM Basic”. This comparison will now be described in reference to FIGS. 21A-C.

FIG. 21A shows a graph 2102, which illustrates the performance of the three extraction approaches for a Foreman test sequence, which is a video of a foreman. The y-axis is PSNR (in dB) and the x-axis is the bit rate (in kbps). Graph 2102 includes extraction data 2108 that was extracted in accordance with aspects of the present invention, JSVM QL data 2110 and JSVM Basic data 2112.

FIG. 21B shows a graph 2104, which illustrates the performance of the three extraction approaches for a City test sequence, which is a video of a city landscape. The y-axis is PSNR (in dB) and the x-axis is the bit rate (in kbps). Graph 2104 includes invention extraction data 2114 that was extracted in accordance with aspects of the present invention, JSVM QL data 2116 and JSVM Basic data 2118.

FIG. 21C shows a graph 2106, which illustrates the performance of the three extraction approaches for a Bus test sequence, which is a video of a bus. The y-axis is PSNR (in dB) and the x-axis is the bit rate (in kbps). Graph 2106 includes the extraction data 2121 that was extracted in accordance with aspects of the present invention, JSVM QL data 2122 and JSVM Basic data 2124.

As demonstrated by graphs 2102, 2104 and 2106 the extraction scheme in accordance with aspects of the present invention outperforms both of the JSVM extraction schemes by a maximum of over 1 dB. The provided gain of the extraction scheme in accordance with aspects of the present invention is mainly due to the accurate estimation of the distortion for any substream, which allows the bit extractor to freely select NAL units with the most contribution to the video quality. The JSVM QL extraction, on the other hand, only orders NAL units within a quality plane and therefore, provides a limited gain. The JSVM basic extraction scheme performs the worst, as expected, since it only uses the high level syntax elements of the NAL units to order them and thus, is unaware of their impact on the quality of the sequence.

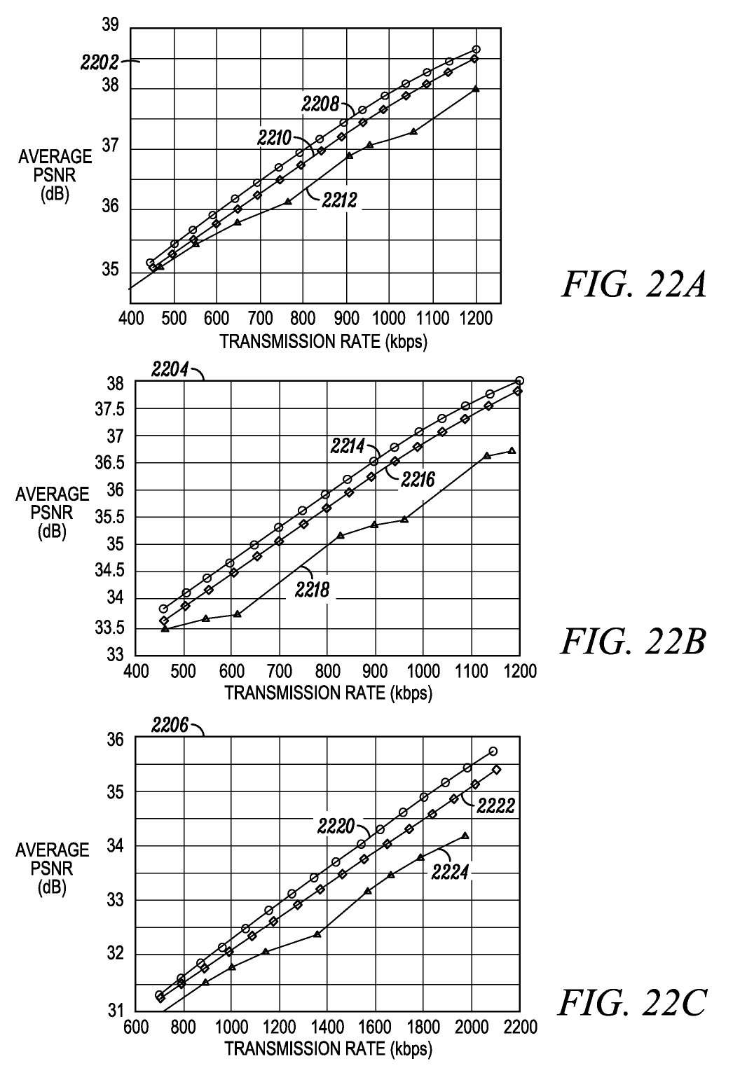

To evaluate the performance of the unequal error protection (UEP) scheme, a memoryless channel with a packet loss rate of 10% was considered. The three transmission schemes considered were: 1) joint extraction with UEP in accordance with aspects of the present invention, referred to as “OptExtraction+UEP”; 2) a source extraction scheme in accordance with aspects of the present invention, with the best fixed channel coding rate obtained exhaustively from the set of channel coding rates for each transmission bit rate, referred to as “Opt Extraction+EEP”; and 3) JSVM basic extraction with the best fixed channel coding rate, referred to as “JSVM Basic+EEP”. In order to build a fair comparison criteria, it is assumed that the base layer of the key frames are coded using the lowest channel coding rate and therefore always received intact for all three schemes. The variation in performance of these three extraction and error protection schemes will now be discussed in reference to FIGS. 22A-C.

FIG. 22A shows a graph 2202, which illustrates the average PSNR of the decoded sequence of the three extraction and error protection schemes for the Foreman test sequence. The y-axes show average PSNR (in dB) and x-axes show the transmission rate (in kbps). Graph 2202 includes extraction data+UEP data 2208 (wherein the extraction data was extracted in accordance with aspects of the present invention), present invention extraction+EEP data 2210 (wherein the extraction data was extracted in accordance with aspects of the present invention) and JSVM Basic+EEP data 2012.

FIG. 22B shows a graph 2204, which illustrates the average PSNR of the decoded sequence of the three extraction and error protection schemes for the City test sequence. The y-axes show average PSNR (in dB) and x-axes show the transmission rate (in kbps). Graph 2204 includes extraction data+UEP data 2214 (wherein the extraction data was extracted in accordance with aspects of the present invention), extraction data+EEP data 2216 (wherein the extraction data was extracted in accordance with aspects of the present invention) and JSVM Basic+EEP data 2218.

FIG. 22C shows a graph 2206, which illustrates the average PSNR of the decoded sequence of the three extraction and error protection schemes for the Bus test sequence. The y-axes show average PSNR (in dB) and x-axes show the transmission rate (in kbps). Graph 2206 includes extraction data+UEP data 2220 (wherein the extraction data was extracted in accordance with aspects of the present invention), extraction data+EEP data 2222 (wherein the extraction data was extracted in accordance with aspects of the present invention) and JSVM Basic+EEP data 2224.

As demonstrated by graphs 2202, 2204, and 2206 the joint extraction with UEP of the present invention outperforms the other two schemes. Note that packets in equal error protection schemes may be lost with a constant probability. However, the UEP scheme distributes parity bits such that important packets have smaller loss probabilities and therefore some less important packets have higher loss probabilities. Note that while the UEP scheme in accordance with aspects of the present invention provides added performance, most of the performance gain comes from the optimized source extraction scheme of the present invention.

As discussed above, an accordance with aspects of the present invention, a system and method accurately and efficiently estimates the quality degradation (distortion) resulting from discarding an arbitrary number of NAL units from multiple layers of a bitstream. Then, this estimated distortion is used to assign Quality Layers to NAL units for a more efficient extraction.

The foregoing description of various preferred embodiments of the invention have been presented for purposes of illustration and description. It is not intended to be exhaustive or to limit the invention to the precise forms disclosed, and obviously many modifications and variations are possible in light of the above teaching. The exemplary embodiments, as described above, were chosen and described in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

What is claimed as new and desired to be protected by Letters Patent of the United States is:

1. A device for use with a frame generating portion that is arranged to receive picture data corresponding to a plurality of pictures and to generate encoded video data for transmission across a transmission channel having an available bandwidth, the frame generating portion being operable to generate a frame for each of the plurality of pictures to create a plurality of frames, the encoded video data being based on the received picture data, said device comprising:
a distortion estimating portion operable to estimate a distortion;
an inclusion determining portion operable to establish an inclusion boundary based on the estimated distortion; and
an extracting portion operable to extract a frame from the plurality of frames based on the inclusion boundary.

2. The device of claim 1, wherein said distortion estimating portion is operable to estimate the distortion as a minimum distortion for the available bandwidth.

3. The device of claim 2, wherein said distortion estimating portion is operable to estimate the distortion as a minimum distortion for the available bandwidth based on an estimated loss of one of the plurality of frames during transmission across the transmission channel.

4. The device of claim 2, wherein said distortion estimating portion is operable to estimate the distortion as a minimum distortion for the available bandwidth based on a known change in an estimated loss of one of the plurality of frames during transmission across the transmission channel.

5. The device of claim 1, wherein said distortion estimating portion is operable to estimate the distortion as a predetermined acceptable distortion.

6. The device of claim 5, wherein said distortion estimating portion is operable to estimate the distortion as a minimum distortion for the available bandwidth based on an estimated loss of one of the plurality of frames during transmission across the transmission channel.

7. The device of claim 5, wherein said distortion estimating portion is operable to estimate the distortion as a minimum distortion for the available bandwidth based on a known change in an estimated loss of one of the plurality of frames during transmission across the transmission channel.

8. A method of preparing picture data as encoded data for transmission across a channel having an available bandwidth, the picture data corresponding to a plurality of pictures, the encoded data being based on the picture data, said method comprising:
generating a frame for each of the plurality of pictures to create a plurality of frames;
estimating a distortion;
establishing an inclusion boundary based on the estimated distortion; and
extracting a frame from the plurality of frames based on the inclusion boundary.

9. The method of claim 8, wherein said estimating a distortion comprises estimating the distortion as a minimum distortion for the available bandwidth.

10. The method of claim 9, wherein said estimating the distortion as a minimum distortion for the available bandwidth is based on an estimated loss of one of the plurality of frames during transmission across the transmission channel.

11. The method of claim 9, wherein estimating the distortion as a minimum distortion for the available bandwidth is based on a known change in an estimated loss of one of the plurality of frames during transmission across the transmission channel.

12. The method of claim 8, wherein said estimating the distortion comprises estimating the distortion as a predetermined acceptable distortion.

13. The method of claim 12, wherein said estimating the distortion as a predetermined acceptable distortion is based on an estimated loss of one of the plurality of frames during transmission across the transmission channel.

14. The method of claim 12, wherein said estimating the distortion as a predetermined acceptable distortion is based on a known change an estimated loss of one of the plurality of frames during transmission across the transmission channel.

15. A device-readable media having device-readable instructions stored thereon, the device-readable instructions being capable of instructing a device to perform a method of preparing picture data as encoded data for transmission across a channel having an available bandwidth, the picture data corresponding to a plurality of pictures, the encoded data being based on the picture data, the method comprising:
generating a frame for each of the plurality of pictures to create a plurality of frames;
estimating a distortion;
establishing an inclusion boundary based on the estimated distortion; and
extracting a frame from the plurality of frames based on the inclusion boundary.

16. The device-readable media of claim 15, the device-readable instructions being capable of instructing the device to perform said estimating a distortion by estimating the distortion as a minimum distortion for the available bandwidth.

17. The device-readable media of claim 16, the device-readable instructions being capable of instructing the device to perform said estimating the distortion as a minimum distortion for the available bandwidth based on an estimated loss of one of the plurality of frames during transmission across the transmission channel.

18. The device-readable media of claim 16, the device-readable instructions being capable of instructing the device to perform said estimating the distortion as a minimum distortion for the available bandwidth based on a known change in an estimated loss of one of the plurality of frames during transmission across the transmission channel.

19. The device-readable media of claim 15, the device-readable instructions being capable of instructing the device to perform said estimating the distortion by estimating the distortion as a predetermined acceptable distortion.

20. The device-readable media of claim 19, the device-readable instructions being capable of instructing the device to perform said estimating the distortion as a predetermined acceptable distortion based on an estimated loss of one of the plurality of frames during transmission across the transmission channel.
